(19) United States
(12) Patent Application Publication
(10) Pub. No.: US 2012/0149593 A1
(43) Pub. Date: Jun. 14, 2012

(54) METHODS AND ARRAYS FOR PROFILING DNA METHYLATION

(76) Inventors: James B. Hicks, Cold Spring Harbor, NY (US); Gregory J. Hannon, Huntington, NY (US); Emily Hodges, Huntington, NY (US); Jude Kendall, Bronx, NY (US); Andrew D. Smith, Santa Monica, CA (US)

(21) Appl. No.: 13/145,829

(22) PCT Filed: Jan. 22, 2010
(86) PCT No.: PCT/US2010/000158

§ 371 Date: Feb. 29, 2012

Related U.S. Application Data
(60) Provisional application No. 61/205,834, filed on Jan. 23, 2009.

(51) Int. Cl. C40B 30/04; G06F 19/20; C40B 40/06

(52) U.S. Cl. 506/9; 506/16; 702/20

(57) ABSTRACT

This invention provides methods and arrays for determination of the methylation patterns at single-nucleotide resolution by array-based hybrid selection and next-generation sequencing of bisulfite-treated DNA.

This application claims priority of U.S. Provisional Application No. 61/205,834, filed Jan. 23, 2009, the content of which are incorporated by reference.

The invention disclosed herein was made with government support from Department of the Army grant No. W81XWH04-1-0477. Accordingly, the U.S. Government has certain rights in this invention.

Throughout this application, various publications are referenced by number in brackets. Full citations for these references may be found at the end of the specification immediately preceding the claims. The disclosures of these publications in their entireties are hereby incorporated by reference into this application to more fully describe the state of the art to which this invention pertains.

### BACKGROUND OF THE INVENTION

It has long been known that changes in cellular and organismal characteristics can be inherited without accompanying alterations in genomic sequence [1]. This phenomenon, known as epigenetic inheritance, has been proposed to occur through a number of mechanisms [2]. While histone marks have been posited to carry epigenetic information, the degree to which these protein modifications can be transmitted through meiosis and mitosis is unclear [3,4]. In contrast, patterns of cytosine methylation can be faithfully replicated through cell division and in some cases even passed to an organism's progeny [3,5,6].

In mammals, cytosine methylation occurs mainly at cytosines located 5′ to guanosine in the CpG dinucleotide [5]. In both plants and animals, methylation of dispersed CpG residues within the bodies of genes does not seem to impact expression [7]. However, when cytosine methylation occurs in promoters or regulatory regions, it is most often associated with repression.

There is abundant evidence indicating that methylation of repetitive elements and transposons, which comprise nearly 50% of a typical mammalian genome, is essential for holding these in a transcriptionally silent state [8,9]. Moreover, modifications in differentially methylated regions mark the inactive alleles of imprinted loci [10]. DNA methylation pathways per se are essential for normal development as evident from the study of mice carrying loss of function alleles of Dnmt1, 3a, 3b, or 3L [8,11,12]. Changes in the methylation status of many genes accompany differentiation, suggesting that the accumulation of such modifications throughout the developmental history of a cell reinforces and restricts its fate [13].

Overall, CpG dinucleotides are underrepresented in the genome. This can be attributed to the higher spontaneous deamination rate of methylated residues contributing to a transition, over evolutionary time scales, of CpG to TpG sequences [14]. However, there are genomic regions in which CpG residues are relatively more abundant than in the genome as a whole. These “CpG islands” tend to associate with transcriptional start sites, with roughly one third of mammalian genes containing a CpG island near its promoter. CpG islands are also found within introns and exons, and in intergenic space [15].

The methylation state of CpG dinucleotides is mitotically heritable due to the activity of the maintenance methyltransferase, Dnmt1 [16]. This enzyme recognizes hemi-methylated CpGs and converts them to a symmetrically methylated state. Thus, epigenetic silencing via CpG methylation has been proposed as a stable means of genetic repression, particularly in the context of reinforcing cell differentiation decisions during development [17].

Changes in DNA methylation patterns are also associated with the development of human disease [13,18]. Mutations in MeCP2, a methylcytosine binding protein underlie Rett syndrome, a neurodevelopmental disorder [19]. Moreover, cancer cells show consistent alterations in methylation that correlate with transformation [20]. Overall, tumor genomes are hypomethylated, but focally increased methylation tends to accompany silencing of tumor suppressors, such as p161NK4A, which promotes disease progression.

Despite abundant evidence for a critical role of cytosine methylation and epigenetic inheritance as a driver of normal development and disease, few methods exist that allow reliable, large-scale mapping of methylation states. Antibodies to methylcytosine allow recovery of methylated DNA, which can be hybridized to tiling microarrays to provide a low-resolution picture of the average methylation state of a region [21]. Methylation status can also be gained by coupling methylation sensitive restriction enzymes with microarray analysis or next-generation sequencing [22-24]. However, a detailed understanding of the role of DNA methylation in controlling gene expression requires methods to monitor the state of large numbers of CpG residues at single-base resolution without limitations on the sequences that can be probed.

High-resolution strategies can distinguish methylation states in a semi-quantitative, allele-specific manner at individual CpGs within a defined region. Established protocols that positively identify 5-methylcytosine residues in single strands of genomic DNA exploit the sodium bisulfite-induced deamination of cytosine to uracil. Under denaturing conditions, only methylated cytosines are protected from conversion. To measure methylation levels, bisulfite conversion has been combined with restriction analysis (COBRA) [40], base-specific cleavage and mass spectrometry [41, 42], real-time PCR (MethyLight) [43], and pyrosequencing [44]. However, these methods are generally limited by their scalability and cost.

Bisulfite sequencing represents the most comprehensive, high-resolution method for determining DNA methylation states. Like SNP detection, the accurate quantification of variable methylation frequencies requires high sampling of individual molecules. High-throughput, single-molecule sequencing instruments have facilitated the genome-wide application of this approach. For example, direct shotgun bisulfite sequencing provided adequate coverage depth and proved cost-effective for a small genome like Arabidopsis (119 Mbp) [45]. However, these approaches are currently impractical for routine application in complex mammalian genomes, and simplification of DNA fragment populations (genome partitioning) is still required to boost sampling depth of individual CpG sites [46, 47]. This problem becomes compounded as one considers that, within a multicellular organism, there are probably at least as many epigenomic states as there are cell types. Therefore, to understand the impact of epigenetic variation will require both detailed reference maps and the ability to interrogate regions of those reference maps in many samples and cell types at high resolution.

### SUMMARY OF THE INVENTION

A process is provided for determining the DNA methylation state of CpG dinucleotides within a plurality of regions of interest of genomic DNA, the method comprising:
a) providing fragments of the genomic DNA;
b) ligating adaptors to the 5′ and to the 3′ ends of the fragmented DNA of step a) to form primary ligated material, wherein cytosine residues of the adaptors have a protecting group which inhibits deamination resulting from bisulfite treatment;
c) subjecting the primary ligated material of step b) to bisulfite treatment to form bisulfite-converted material, such that unprotected cytosines of the primary ligated material are converted to uridines;
d) amplifying the bisulfite-converted material by PCR amplification using primer sequences present on the adaptors to generate an amplification product, such that uridines in the sequence of the bisulfite-converted material of step c) are thymidines in the sequence of the amplification product;
e) denaturing the amplification product to form single-stranded DNA fragments;
a) capturing single-stranded DNA fragments comprising sequences spanning regions of within the plurality of regions of the genome by hybridizing the single-stranded DNA fragments of step e) to a capture array which comprises a plurality of probe sets, wherein each probe set consists of one, two, three or four two-probe subsets, such that each two-probe subset consist of either
   i) a first probe having a sequence which corresponds to the sequence of a segment of a single strand within a region comprising a CpG dinucleotide, with the exception that every cytosine (C) residue of the segment of the single strand of DNA is a thymine (T) residue in the first probe; and
   ii) a second probe having a sequence which corresponds to the sequence of the same segment of the single strand comprising a CpG dinucleotide, with the exception that every cytosine (C) residue of the segment, other than the cytosine (C) residue of the CpG dinucleotide, is a thymine (T) residue in the second probe; or
   iii) a probe fully complementary to the first probe; and
   iv) a probe fully complementary to the second probe;
g) eluting the captured single-stranded DNA fragments and sequencing the eluted fragments to obtain sequence reads; and
h) mapping the sequence reads to a reference genome,
thereby determining the methylation state of CpG dinucleotides within the regions of interest.

A DNA array is provided comprising a plurality of probe sets, each probe set consisting of one, two, three or four two-probe subsets, each two-probe subset consisting of
i) a first probe having a sequence which corresponds to the sequence of a segment of a single strand within a region comprising a CpG dinucleotide, with the exception that every cytosine (C) residue of the segment of the single strand of DNA is a thymine (T) residue in the first probe; and
ii) a second probe having a sequence which corresponds to the sequence of the same segment of the single strand comprising a CpG dinucleotide, with the exception that every cytosine (C) residue of the segment, other than the cytosine (C) residue of the CpG dinucleotide, is a thymine (T) residue in the second probe; or
iii) a probe fully complementary to the first probe; and
iv) a probe fully complementary to the second probe.

A process is provided for obtaining information for as determining the DNA methylation state of CpG dinucleotides within a plurality of regions of interest of genomic DNA comprising:
a) producing fragments of the genomic DNA;
b) ligating adaptors to the 5′ and to the 3′ ends of the fragmented DNA of step a) to form primary ligated material, wherein cytosine residues of the adaptors have a protecting group which inhibits deamination resulting from bisulfite treatment;
c) subjecting the primary ligated material of step b) to bisulfite treatment to form bisulfite-converted material, such that unprotected cytosines of the primary ligated material are converted to uridines;
d) amplifying the bisulfite-converted material by PCR amplification using primer sequences present on the adaptors to generate an amplification product, such that uridines in the sequence of the bisulfite-converted material of step c) are thymidines in the sequence of the amplification product;
e) denaturing the amplification product to form single-stranded DNA fragments;
f) capturing single-stranded DNA fragments comprising sequences spanning regions of within the plurality of regions of the genome by hybridizing the single-stranded DNA fragments of step e) to a capture array which-comprises a plurality of probe sets, wherein each probe set consists of one, two, three or four two-probe subsets, such that each two-probe subset consist of
   i) a first probe having a sequence which corresponds to the sequence of a segment of a single strand within a region comprising a CpG dinucleotide, with the exception that every cytosine (C) residue of the segment of the single strand of DNA is a thymine (T) residue in the first probe; and
   ii) a second probe having a sequence which corresponds to the sequence of the same segment of the single strand comprising a CpG dinucleotide, with the exception that every cytosine (C) residue of the segment, other than the cytosine (C) residue of the CpG dinucleotide, is a thymine (T) residue in the second probe; or
   iii) a probe fully complementary to the first probe; and
   iv) a probe fully complementary to the second probe; and
g) eluting the captured single-stranded DNA fragments and sequencing the eluted fragments to obtain sequence reads, thereby obtaining the information for determining the DNA methylation state.

The present invention may be more fully understood by reference to the following detailed description of the invention, examples of specific embodiments of the invention and the figures which are provided for purpose of illustration.

### BRIEF DESCRIPTION OF THE FIGURES

FIG. 1. Schematic of the bisulfite capture method. Genomic DNA was randomly fragmented according to the standard Illumine® protocol and ligated to custom-synthesized adapters in which each cytosine “C” was replaced by 5-methly-cytosine “5-meC”. The ligation was size fractionated to select material from 150-300 bases in length. The gel-eluted material was treated with sodium bisulfite and then PCR enriched using Illumine® Paired-End PCR primers. The resulting products were hybridized to custom-synthesized Agilentm 244K arrays containing probes complementary to the A-rich strands. The A-rich stand can also be called C-rich strand (B). Hybridizations were carried out in Agilentm array CGH buffers under standard conditions. After washing, captured fragments were eluted in water at 95° C. and amplified again using Illumine® Paired-End PCR primers prior to quantification and sequencing on the GA2 platform.

FIG. 2. Potential number of mismatches to capture probes. Plotted are the number of capture probes (Y-axis) versus the number of possible mismatches that would occur if CpGs in their converted genomic target were methylated at random (CpG number per probe/2).

FIG. 3. Mapping bisulfite treated reads. (A) Reads were mapped to the reference genome by minimizing the number of potential mismatches. Any T in a read incurs no penalty for aligning with a C in the genome, and any C in a read is penalized for aligning with a T in the genome. (B) Quality scores are converted to mismatch penalties by assigning a penalty of 0 to the consensus bases, and penalizing non-consensus bases proportionately to the difference between their quality score and the consensus base score. A difference of 80 (representing the maximum possible range at a single position) is equated with a penalty of 1.

FIG. 4. Calling the methylation state of an individual CpG. Calls are determined by considering both methylation rates of reads mapping over the CpG and the width of the 95% confidence interval for the estimate. (A) CpGs for which the confidence interval is contained below 0.25 are called unmethylated; (B) CpGs for which the confidence interval is entirely above 0.75 are called methylated. Partial methylation is called confidently if the confidence interval has width smaller than 0.25 (C) and no call is made if the interval is wider than 0.25 (D).

FIG. 5. Profiles of CpG island methylation. Methylation states are shown for all analyzed CpG islands across chromosomes 1 and X for SKN-1 (panels A and C) and MDA-MB-231 (panels B and D). Reads called as G (black), T (orange) and C (blue) for each CpG dinucleotide in the target regions are plotted on the Y axis, with chromosome position plotted on the X-axis. Islands with minimal methylation appear as orange bars (examples marked with green arrows). Islands with high methylation levels appear blue. Those, which exhibit higher methylation in MB-231, are marked with red arrows. Islands with partial methylation (see FIG. 6) expose the black symbols (G calls) indicating that calls are split between C and T. Black arrows (panel D) designated islands that are partially methylated and may have undergone dosage compensation in the female cell line.

FIG. 6. Examples of CpG islands showing different methylation states. Histograms of individual CpG islands are shown, plotting nucleotides called as G (black), T (orange) or C (blue) for individual CpG dinucleotides within the target regions. Data for approximately 400,000 mappable reads is plotted for SKN-1 and MB-231 (as indicated). Horizontal pairs are plotted on the same scale. CpG dinucleotides are plotted on the X-axis according to chromosome position. Panels A and B show an island near the USP31 TSS, and panels C and D show an island near the third exon of NISCH. Both show similar methylation in the two cell lines, being consistently unmethylated or methylated, respectively. Panels E and F show an island in ALX3, which becomes more methylated in the tumor line. Panels G and H show an island on Chromosome X, near AK098893, which is unmethylated in male SKN-1 cells and partially methylated over the extent of the island in the female MDA-MB231 line. An intermediate state of methylation on an autosome in the tumor line is shown in Panels I and J. Panels K and L show an island near and SSTR4 with a complex methylation pattern in which domains of the island vary between lines.

FIG. 7. Comparison of Capture-Illumina and conventional bisulfite resequencing. Two regions (A and B) are shown. The upper panel of each depicts a chromatogram reconstructed based upon summing individual Illumine® reads. The lower panel represents an actual capillary sequence trace from fragments amplified by PCR from bisulfite treated DNA of the same cell line. Purple shading shows methylated CpGs. Green shading shows converted Cs that are not in CpG dinucleotides. Gray shading shows two partially methylated CpGs in Panel B.

FIG. 8. Blocks of DNA methylation overlap exons, histone H3K36me3 and histone H3K4me2 marks. An example of a CGI that overlaps multiple exons is shown (A). Annotated gene tracks were downloaded from the UCSC genome browser. The gene tracks are displayed above a histogram plotting methylation frequencies at specific CpG sites positioned along the region shown. Absolute read counts and actual distance between CpG sites are depicted in the upper histogram, whereas the lower histogram shows the proportion of methylated and unmethylated Cs at each site. Boxes with dashed borders highlight blocks of methylation exons. The edges of the block are defined by the point at which the proportion of reads methylated is at least 0.5. Two examples for which the distribution of histone marks along the CGI reflects DNA methylation status are shown (B). To display the ChIP-seq data, a wiggle track was created for each histone mark by counting reads mapped in 5-base windows across the genome.

FIG. 9. Asymmetry in Read Depth is Correlated with the Density of T Residues. The Y axis represents the read depth for the plus and minus strands (blue lines) above and below the X axis along a particular sequence of 1500 base pairs. The Y axis also reads in the same scale the percentage of T residues in the fully converted sequence for a sliding window 50 bp in length.

### DETAIL DESCRIPTION OF THE INVENTION

A process is provided for determining the DNA methylation state of CpG dinucleotides within a plurality of regions of interest of genomic DNA, the method comprising:
a) providing fragments of the genomic DNA;
b) ligating adaptors to the 5′ and to the 3′ ends of the fragmented DNA of step a) to form primary ligated material, wherein cytosine residues of the adaptors have a protecting group which inhibits deamination resulting from bisulfite treatment;
c) subjecting the primary ligated material of step b) to bisulfite treatment to form bisulfite-converted material, such that unprotected cytosines of the primary ligated material are converted to uridines;
d) amplifying the bisulfite-converted material by PCR amplification using primer sequences present on the adaptors to generate an amplification product, such that uridines in the sequence of the bisulfite-converted material of step c) are thymidines in the sequence of the amplification product;
e) denaturing the amplification product to form single-stranded DNA fragments;
f) capturing single-stranded DNA fragments comprising sequences spanning regions of within the plurality of regions of the genome by hybridizing the single-stranded DNA fragments of step e) to a capture array which comprises a plurality of probe sets, wherein each probe set consists of one, two, three or four two-probe subsets, such that each two-probe subset consist of either
   i) a first probe having a sequence which corresponds to the sequence of a segment of a single strand within a region comprising a CpG dinucleotide, with the exception that every cytosine (C) residue of the segment of the single strand of DNA is a thymine (T) residue in the first probe; and
   ii) a second probe having a sequence which corresponds to the sequence of the same segment of the single strand comprising a CpG dinucleotide, with the exception that every cytosine (C) residue of the segment, other than the cytosine (C) residue of the CpG dinucleotide, is a thymine (T) residue in the second probe; or
   iii) a probe fully complementary to the first probe; and
   iv) a probe fully complementary to the second probe;
g) eluting the captured single-stranded DNA fragments and sequencing the eluted fragments to obtain sequence reads; and
h) mapping the sequence reads to a reference genome,
thereby determining the methylation state of CpG dinucleotides within the regions of interest.

In an embodiment of the instant process, the DNA fragments of step a) are obtained by mechanical or enzymatic shearing.

In an embodiment of the instant process before step b), the fragmented DNA is selected by size exclusion.

In an embodiment of the instant process, the fragmented DNA consists essentially of DNA molecules each from 45-500 bp in length.

In an alternative embodiment the fragmented DNA consists essentially of DNA molecules each from 150-300 bp.

In an embodiment of the instant process, the bisulfite treatment comprises of treatment with a bisulfite, a disulfite or a hydrogensulfite solution.

In an embodiment of the instant process, the bisulfite treatment comprises contacting the primary ligated material with sodium bisulfite.

In an embodiment of the instant process, the protecting group which inhibits sulfonation of the cytosine residues is a methyl group on the 5′ position of cytosine residues.

In an embodiment of the instant process, the PCR amplification is performed using pair-end adaptor compatible primers.

In an embodiment of the instant process, the PCR amplification is performed using polymerase capable of amplifying highly denatured, uracil-rich templates.

In an embodiment of the instant process, the polymerase is a blend of Taq/Pwo DNA polymerase.

In an embodiment of the instant process, the capture of step f) produces an enrichment of 784 to 1459 fold of regions of interest.

In an embodiment of the instant process, the capture array is designed to capture single-stranded DNA fragments of step e) with the fewest total number of Cs and Ts.

In alternative embodiment the T residue density can be between the range of 50% and 90%.

In an embodiment of the instant process, the capture array is designed to capture single-stranded DNA fragments of step e) with a T residue density of less than 60%.

In alternative embodiment the C and T residue density is less than or equal to 50%.

In an embodiment of the instant process, each probe corresponds to a segment of a CpG island within the genome.

In alternative embodiment the segment of the CpG island is 40-250 nucleotides.

In alternative embodiment the segment is centered within the CpG island.

In alternative embodiment the segment is free of repetitive sequences.

In an embodiment of the instant process, the DNA is obtained from a biopsy specimen, a cell line, an autopsy specimen, a forensic specimen or a paleoentological specimen.

In an embodiment of the instant process, the biopsy specimen is a fractioned biopsy specimen or a microdissected biopsy specimen.

In an embodiment of the instant process, a methylation map of a segment of a genome obtained by detecting methylation of cytosine in CpG dinucleotides within a genome.

A DNA array is provided comprising a plurality of probe sets, each probe set consisting of one, two, three or four two-probe subsets, each two-probe subset consisting of
i) a first probe having a sequence which corresponds to the sequence of a segment of a single strand within a region comprising a CpG dinucleotide, with the exception that every cytosine (C) residue of the segment of the single strand of DNA is a thymine (T) residue in the first probe; and
ii) a second probe having a sequence which corresponds to the sequence of the same segment of the single strand comprising a CpG dinucleotide, with the exception that every cytosine (C) residue of the segment, other than the cytosine (C) residue of the CpG dinucleotide, is a thymine (T) residue in the second probe; or
iii) a probe fully complementary to the first probe; and
iv) a probe fully complementary to the second probe.

In an embodiment of the instant DNA array, if two, three or four two-probe subsets are present in each probe set of the DNA microarray, each two-probe subset within each probe set is different.

In an embodiment of the instant DNA array, each probe set consists of two different two-probe subsets.

In an embodiment of the instant DNA array
a) one of the two different two-probe subsets consists of
   i) a first probe having a sequence which corresponds to the sequence of a segment of a single strand within a region comprising a CpG dinucleotide, with the exception that every cytosine (C) residue of the segment of the single strand of DNA is a thymine (T) residue in the first probe; and
   ii) a second probe whose sequence which corresponds to the sequence of the same segment of the single strand comprising a CpG dinucleotide, with the exception that every cytosine (C) residue of the segment, other than the cytosine (C) residue of the CpG dinucleotide, is a thymine (T) residue in the second probe, and
b) the other of the two different two-probe subsets consists of
   i) a third probe having a sequence which corresponds to the sequence of the full complement of the segment of the single strand comprising the CpG dinucleotide, with the exception that every cytosine (C) residue of the known single stranded DNA segment is a thymine (T) residue in the first probe; and
   ii) a fourth probe having a sequence which corresponds to the sequence of the full complement of the segment of the single strand comprising a CpG dinucleotide, with the exception that every cytosine (C) residue of the segment, other than the cytosine (C) residue of the CpG dinucleotide, is a thymine (T) residue in the second probe.
   Wherein the segments of steps a) (i) and a)(ii) are the same segment in length and sequence.
   Wherein the segments of steps b)(i) and b)(ii) are the same segment in length and sequence.

In an embodiment of the instant DNA array,
a) one of the two different two-probe subsets consists of
   i) a first probe having a sequence which corresponds to the sequence of a segment of a single strand within a region comprising a CpG dinucleotide, with the exception that every cytosine (C) residue of the segment of the single strand of DNA is a thymine (T) residue in the first probe; and
   ii) a second probe whose sequence which corresponds to the sequence of the same segment of the single strand comprising a CpG dinucleotide, with the exception that every cytosine (C) residue of the segment, other than the cytosine (C) residue of the CpG dinucleotide, is a thymine (T) residue in the second probe, and
b) the other of the two different two-probe subsets consists of
   i) a third probe which is fully complementary to a probe having a sequence which corresponds to the sequence of the full complement of the segment of the single strand comprising the CpG dinucleotide, with the exception that every cytosine (C) residue of the known single stranded DNA segment is a thymine (T) residue in the first probe; and
   ii) a fourth probe which is fully complementary to a probe having a sequence which corresponds to the sequence of the full complement of the segment of the single strand comprising the CpG dinucleotide, with the exception that every cytosine (C) residue of the segment, other than the cytosine (C) residue of the CpG dinucleotide, is a thymine (T) residue in the second probe.
   Wherein the segments of steps a) (i) and a) (ii) are the same segment in length and sequence.
   Wherein the segments of steps b)(i) and b)(ii) are the same segment in length and sequence.

In an embodiment of the instant DNA array,
a) one of the two different two-probe subsets consists of
   i) a first probe which is fully complementary to a probe having a sequence corresponding to the sequence of a segment of a single strand within a region comprising a CpG dinucleotide, with the exception that every cytosine (C) residue of the segment of the single strand of DNA is a thymine (T) residue in the first probe; and
   ii) a second probe which is fully complementary to a probe having a sequence corresponding to the sequence of the same segment of the single strand comprising a CpG dinucleotide, with the exception that every cytosine (C) residue of the segment, other than the cytosine (C) residue of the CpG dinucleotide, is a thymine (T) residue in the second probe, and
b) the other of the two different two-probe subsets consists
   i) a third probe having a sequence which corresponds to the sequence of the full complement of the segment of the single strand comprising a CpG dinucleotide, with the exception that every cytosine (C) residue of the known single stranded DNA segment is a thymine (T) residue in the first probe; and
   ii) a fourth probe having a sequence which corresponds to the sequence of the full complement of the segment of the single strand comprising a CpG dinucleotide, with the exception that every cytosine (C) residue of the segment, other than the cytosine (C) residue of the CpG dinucleotide, is a thymine (T) residue in the second probe.
   Wherein the segments of steps a)(i) and a)(ii) are the same segment in length and sequence.
   Wherein the segments of steps b)(i) and b)(ii) are the same segment in length and sequence.

In an embodiment of the instant DNA array,
a) one of the two different two-probe subsets consists of
   i) a first probe which is fully complementary to a probe having a sequence corresponding to the sequence of a segment of a single strand within a region comprising a CpG dinucleotide, with the exception that every cytosine (C) residue of the segment of the single strand of DNA is a thymine (T) residue in the first probe; and
   ii) a second probe which is fully complementary to a probe having a sequence corresponding to the sequence of the same segment of the single strand comprising a CpG dinucleotide, with the exception that every cytosine (C) residue of the segment, other than the cytosine (C) residue of the CpG dinucleotide, is a thymine (T) residue in the second probe, and
b) the other of the two different two-probe subsets consists
   i) a third probe which is fully complementary to a probe having a sequence corresponding to the sequence of the full complement of the segment of the single strand comprising a CpG dinucleotide, with the exception that every cytosine (C) residue of the known single stranded DNA segment is a thymine (T) residue in the first probe; and
   ii) a fourth probe which is fully complementary to a probe having a sequence corresponding to the sequence of the full complement of the segment of the single strand comprising a CpG dinucleotide, with the exception that every cytosine (C) residue of the segment, other than the cytosine (C) residue of the CpG dinucleotide, is a thymine (T) residue in the second probe.
   Wherein the segments of steps a)(i) and a)(ii) are the same segment in length and sequence.
   Wherein the segments of steps b)(i) and b)(ii) are the same segment in length and sequence

In an embodiment of the instant DNA array, the probes are attached to a solid support.

In an embodiment of the instant DNA array, the array consists of a single contiguous solid support.

In an embodiment of the instant DNA array, the probes are designed to correspond to segments of a genome each of which has a combined total density of C residues plus T residues, excluding C residues of CpG dinucleotides, of less than 50%.

In an embodiment of the instant DNA array, the probes are designed to correspond to a segment of a genome within a CpG island.

In an alternative embodiment the segment within the CpG island is 40-250 nucleotides.

In an alternative embodiment the segment is centered within the CpG island.

In an alternative embodiment the segment is free of repetitive sequences.

A process is provided for obtaining information for determining the DNA methylation state of CpG dinucleotides within a plurality of regions of interest of genomic DNA comprising:
a) producing fragments of the genomic DNA;
b) ligating adaptors to the 5′ and to the 3′ ends of the fragmented DNA of step a) to form primary ligated material, wherein cytosine residues of the adaptors have a protecting group which inhibits deamination resulting from bisulfite treatment;
c) subjecting the primary ligated material of step b) to bisulfite treatment to form bisulfite-converted material, such that unprotected cytosines of the primary ligated material are converted to uridines;
d) amplifying the bisulfite-converted material by PCR amplification using primer sequences present on the adaptors to generate an amplification product, such that uridines in the sequence of the bisulfite-converted material of step c) are thymidines in the sequence of the amplification product;
e) denaturing the amplification product to form single-stranded DNA fragments;
f) capturing single-stranded DNA fragments comprising sequences spanning regions of within the plurality of regions of the genome by hybridizing the single-stranded DNA fragments of step e) to a capture array which comprises a plurality of probe sets, wherein each probe set consists of one, two, three or four two-probe subsets, such that each two-probe subset consist of
   i) a first probe having a sequence which corresponds to the sequence of a segment of a single strand within a region comprising a CpG dinucleotide, with the exception that every cytosine (C) residue of the segment of the single strand of DNA is a thymine (T) residue in the first probe; and
   ii) a second probe having a sequence which corresponds to the sequence of the same segment of the single strand comprising a CpG dinucleotide, with the exception that every cytosine (C) residue of the segment, other than the cytosine (C) residue of the CpG dinucleotide, is a thymine (T) residue in the second probe; or
   iii) a probe fully complementary to the first probe; and
   iv) a probe fully complementary to the second probe; and
g) eluting the captured single-stranded DNA fragments and sequencing the eluted fragments to obtain sequence reads, thereby obtaining the information for determining the DNA methylation state.

In an embodiment a computer implemented process for determining the DNA methylation state of CpG dinucleotides within a plurality of regions of interest of genomic DNA, the method comprising
a) inputting the information obtained by the instant process into a mapping algorithm;
b) matching each sequence read to a reference genome using the mapping algorithm;
c) excluding from consideration portions of the reference genome that have no probability of matching the sequence read; and
d) assigning fractional mismatch penalties based upon the certainty of a base prediction, wherein the certainty of the base prediction takes into account fractional conversions of cytosines to thymine.

In an embodiment of the instant process, using mismatch counts from RMAPBS algorithms.

In an embodiment of the instant process, using base-call quality scores from RMAPBSQ algorithms.

In an embodiment of the instant process, accounts for cytosine to thymine conversions at unmethylated cytosines.

In an embodiment of the instant process, accounts for cytosines protected from conversion by methylation.

In an embodiment of the instant process, first excludes much of the genome from consideration.

In an embodiment of the instant process, assigns a fractional mismatch penalty based on the certainty of a base prediction and takes into account that a large fraction of cytosine's are converted to thymine's.

In an embodiment of the instant process, a high quality call for G, C, or A results in a strong penalty for any mismatch.

In an embodiment of the instant process, a less quality call for G, C, or A results in a intermediate penalty for any mismatch.

In an embodiment of the instant process, a less quality call for G, C, or A results in a intermediate penalty for any mismatch.

In an embodiment of the instant process, a less accounts for potential T calls having an equal probability of originating from a genomic T or C.

In an embodiment of the instant process, a higher probability for T call then a C call results In the lower mismatch penalty for T which is also assigned to C.

The present invention provides methods and arrays for determination of the methylation patterns at single-nucleotide resolution by array-based hybrid selection and next-generation sequencing of bisulfite-treated DNA.

### TERMS

For the purpose of this invention, different words and phrases are defined as follows:

As used herein, the term “methylation” refers to the covalent attachment of a methyl group at the C5-position of the nucleotide base cytosine within the CpG dinucleotides of genomic region of interest. The term “methylation state” or refers to the presence or absence of 5-methyl-cytosine (“5-Me”) at one or a plurality of CpG dinucleotides within a DNA sequence. A methylation site is a sequence of contiguous linked nucleotides that is recognized and methylated by a sequence specific methylase. A methylase is an enzyme that methylates (i.e., covalently attaches a methyl group) one or more nucleotides at a methylation site.

As used here, the term “CpG islands” are short DNA sequences rich in CpG dinucleotide. The term “CpG site” refers to a CpG dinucleotide. In mammalian genomes, the CpG dinucleotide occur about 20% as frequently as expected based on the overall C+G content. A “CpG island” maybe defined as an area of DNA that is enriched in CpG dinucleotide sequences (cytosine and guanine nucleotide bases) compared to the average distribution within the genome. A generally accepted CpG island constitutes 1) a region of at least 200-bp of DNA, 2) a G+C content of at least 50% and 3) observed CpG/expected CpG ratio of least 0.6. as described by Gardiner-Garner and Frommer. Another generally accepted CpG island constitutes 1) a region of at least 500-bp of DNA, 2) a G+C content of at least 55% and 3) observed CpG/expected CpG ratio of least 0.65 as described by Takai and Jones. CpG islands can be computationally annotated using various criteria. Commonly used criteria are by Gardiner-Garden and Frommer, a modified version of Gardiner-Garden and Frommer used for the UCSC Genome Browser Database, and Takai and Jones.

As used herein, the term “amplifying” refers to the process of synthesizing nucleic acid molecules that are complementary to one or both strands of a template nucleic acid. Amplifying a nucleic acid molecule typically includes denaturing the template nucleic acid, annealing primers to the template nucleic acid at a temperature that is below the melting temperatures of the primers, and enzymatically elongating from the primers to generate an amplification product. The denaturing, annealing and elongating steps each can be performed once. Generally, however, the denaturing, annealing and elongating steps are performed multiple times such that the amount of amplification product is increasing, often times exponentially, although exponential amplification is not required by the present methods. Amplification typically requires the presence of deoxyribonucleoside triphosphates, a DNA polymerase enzyme and an appropriate buffer and/or co-factors for optimal activity of the polymerase enzyme. The term “amplification product” refers to the nucleic acid sequences, which are produced from the amplifying process as defined herein.

As used herein, the term “target sequence” refers the DNA sequence of interest in a substance which are to be interrogated by binding to the capture probes immobilized in an array.

As used herein, the term “capture” refers to the process of hybridizing nucleic acid sequence which is complementary to the “capture probe.” Capture refers to the process of hybridizing nucleic acid sequence which is complementary to “substrates” immobilized to the solid phase microarray, wherein “substrate” refers to short nucleic acid sequences which are known and their location on the solid phase microarray are predetermined. The capture tag or probe comprising a “sequence complementary to the substrate” may be immobilized to the solid phase microarray by hybridizing to its complementary “substrate sequence”.

As used herein, the term “probe arrays” refers to the array of N different biosites deposited on a reaction substrate which serves to interrogate mixtures of target molecules or multiple sites on a single target molecule administered to the surface of the array.

As used herein, the phrase “bisulfite treatment” refers to the treatment of nucleic acid with a reagent used for the bisulfite conversion of cytosine to uracil. Examples of bisulfite conversion reagents include but are not limited to treatment with a bisulfite, a disulfite or a hydrogensulfite compound.

As used herein, the phrase “bisulfite-converted material” refers to a nucleic acid that has been contacted with bisulfite ion in an amount appropriate for bisulfite conversion protocols known in the art. Thus, the term “bisulfite-converted material” includes nucleic acids that have been contacted with, for example, magnesium bisulfite or sodium bisulfite, prior to treatment with base.

As used herein, the term “read” or “sequence read” refers to the nucleotide or base sequence information of a nucleic acid that has been generated by any sequencing method. A read therefore corresponds to the sequence information obtained from one strand of a nucleic acid fragment. For example, a DNA fragment where sequence has been generated from one strand in a single reaction will result in a single read. However, multiple reads for the same DNA strand can be generated where multiple copies of that DNA fragment exist in a sequencing project or where the strand has been sequenced multiple times. A read therefore corresponds to the purine or pyrimidine base calls or sequence determinations of a particular sequencing reaction.

As used herein, the term “base call” refers to the determination of the identity of an unknown base in a target polynucleotide. Base-calling is made by comparing the degree of hybridization between the target polynucleotide and a probe polynucleotide with the degree of hybridization between a reference polynucleotide and the probe polynucleotide.

As used herein, the term “Library” refers to a collection of nucleic acid molecules (circular or linear). In one preferred embodiment, a library is representative of all of the DNA content of an organism (such a library is referred to as a “genomic” library), or a set of nucleic acid molecules representative of all of the expressed genes (such a library is referred to as a cDNA library) in a cell, tissue, organ or organism. The organism, in general, may be a prokaryote (e.g., bacteria) or a eukaryote (e.g., protoctista, fungi, plants, animals). The plant may be a food producing plant, for example, a cereal plant such as maize (corn), wheat, rice, sorghum or barley. The organism may be a marsupial, a monotreme, a rodent, murine, avian, canine, feline, equine, porcine, ovine, bovine, simian, a monkey, an ape, or a human. A library may also comprise random sequences made by de novo synthesis, mutagenesis of one or more sequences and the like. A library may be contained in one vector.

As used herein, the term “adapter” refers to an oligonucleotide or nucleic acid fragment or segment that can be ligated to nucleic acid molecule of interest. For the purposes of this invention adaptors may, as options, comprise primer binding sites, recognition sites for endonucleases, common sequences and promoters. Preferably, adapters are positioned to be located on both sides (flanking) a particular nucleic acid molecule of interest. In accordance with the invention, adapters may be added to nucleic acid molecules of interest by standard recombinant techniques (e.g. restriction digest and ligation). For example, adapters may be added to a population of linear molecules, (e.g. a genomic DNA which has been cleaved or digested) to form a population of linear molecules containing adapters at one and preferably both termini of all or substantial portion. The adaptor may be entirely or substantially double stranded or entirely single stranded. A double stranded adaptor may comprise two oligonucleotides that are at least partially complementary.

The adaptor may be phosphorylated or unphosphorylated on one or both strands. Adaptors may be used for DNA sequencing. Adaptors may also incorporate modified nucleotides that modify the properties of the adaptor sequence. For example, methylated cytosines may be substituted for cytosines.

In an embodiment of this invention the adapters ligated to genomic DNA to enable cluster generation on the sequencer contain cytosines which were all methylated. This modification protects such adapters from bisulfite conversion, and is taken into account in the downstream applications and analysis of this invention.

As used herein, the “sequence complexity” or “complexity” with regards to a population of polynucleotides refers to the number of different species of polynucleotides present in the population.

As used herein, the term “reference genome” refers to a genome of the same species as that being analyzed for which genome the sequence information is known.

As used herein, term fully complementary refers to the reverse complement.

As used herein, the term “repeat masked region” refers to repetitive sequences in the human genome.

As used herein, the term “better strand” refers to a strand that had fewer cytosines and thymines in the reference genome.

Where a range of values is provided, it is understood that each intervening value, to the tenth of the unit of the lower limit unless the context clearly dictates otherwise, between the upper and lower limit of that range, and any other stated or intervening value In that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

### I. Strategies for Capture of Bisulfite Treated DNA

Strategies that would allow determination of DNA methylation states were developed to expand the utility of capture-based sequencing methods.

Bisulfite treatment changes the sequence of the genomic DNA in ways that are unpredictable in the absence of a priori knowledge of methylation patterns. Therefore, it presents a significant challenge for hybrid selection-based approaches. In principle, one could simply use previously reported methods to capture relevant regions of unconverted genomic DNA and then treat the captured material with sodium bisulfite and amplify it by PCR to reveal methylation states. However, this strategy has several shortcomings. Most importantly, sequence-based capture methods require substantial amounts of input material, in the fractional to several microgram range [25-27]. This would limit the aforementioned approach to samples for which large numbers of homogeneous cells could be obtained. Instead a method suitable for the analysis of very small number of cells, such as tissue stem cells, tumor initiating cells, or microdissected or laser-captured tumor cells was developed. For this reason, a strategy was developed which allows treatment of genomic DNA with bisulfite and amplification of the treated material prior to capture.

a. DNA Library Preparation

Libraries from two model cell lines were prepared, a normal dermal fibroblast cell line, SKN-1, and a breast tumor cell line, MDA-MB-231 (ATCC# HTB-26). Methods similar to those previously devised for genome-wide bisulfite sequencing of Arabidopsis were used [22]. Standard library preparation protocols with a few important modifications were followed to sequence on the Illumine® GA2 platform.

### Example 1

Genomic DNA libraries were generated as described with a few important modifications. Briefly, purified cell line DNA was randomly fragmented by sonication. Alternatively, DNA maybe randomly fragmented using methods such as enzymatic shearing or nebulization. Fragmented DNA was subsequently treated with a mixture of T4 DNA Polymerase, E. coli DNA polymerase I Klenow fragment, and T4 polynucleotide kinase to repair, blunt and phosphorylate ends according to the manufacturer's instructions (Illumina®). The repaired DNA fragments were subsequently 3′ adenylated using Klenow exo-fragment (Illumina®). After each step, the DNA was recovered using the QIAquick peR Purification kit (Qiagen®). Adenylated fragments were ligated to Illumina®-compatible paired-end adaptors, synthesized with 5′-methyl-cytosine instead of cytosine (Illumina®). These adapters enable cluster generation on the sequencer, the substitution of 5′-methyl-cytosine protects the adapters from bisulfite conversion, which may interfere with downstream applications and analysis.

Adaptor ligated DNA ranging from 150-300 bp were extracted by gel purification using the QIAquick® gel extraction kit followed by elution in 30 ul elution buffer.

b. Bisulfite Conversion of Adapter-Ligated DNA

The most accurate and comprehensive method of determining DNA methylation states is bisulfite sequencing [21,29]. Upon treatment of genomic DNA with sodium bisulfite, unmethylated cytosine residues become sulfonated, making them susceptible to hydrolytic deamination. Subsequent desulfonation leaves a uracil in the place of each original cytosine residue. Methylated cytosines are immune to bisulfite-mediated deamination and remain unconverted.

Uracil corresponds to thymine in its base pairing behavior and hybridizes to adenine. 5-methylcytosine does not change its chemical properties with bisulfite treatment, and therefore still has the base pairing behavior of a cytosine (hybridizing with guanine). Therefore, the genomic DNA is converted in such a way that 5-methylcytosine, which originally could not be distinguished from cytosine by its hybridization behavior, can now be detected as the only remaining cytosine using standard molecular biological techniques, such as sequencing.

### Example 2

Following size selection and gel purification, the adapter-ligated DNA was divided into two separate reactions to ensure optimal DNA concentration for subsequent cytosine conversion reactions. Fragments were denatured and treated with sodium bisulfite using the EZ DNA Methylation-Gold Kit™ according to the manufacturer's instructions (Zyme). Lastly, the sample was desulfonated and the converted. Alternatively bisulfite treatment can be performed with a bisulfite, a disulfite or a hydrogensulfite compound.

c. PCR Amplification of Bisulfite Converted DNA

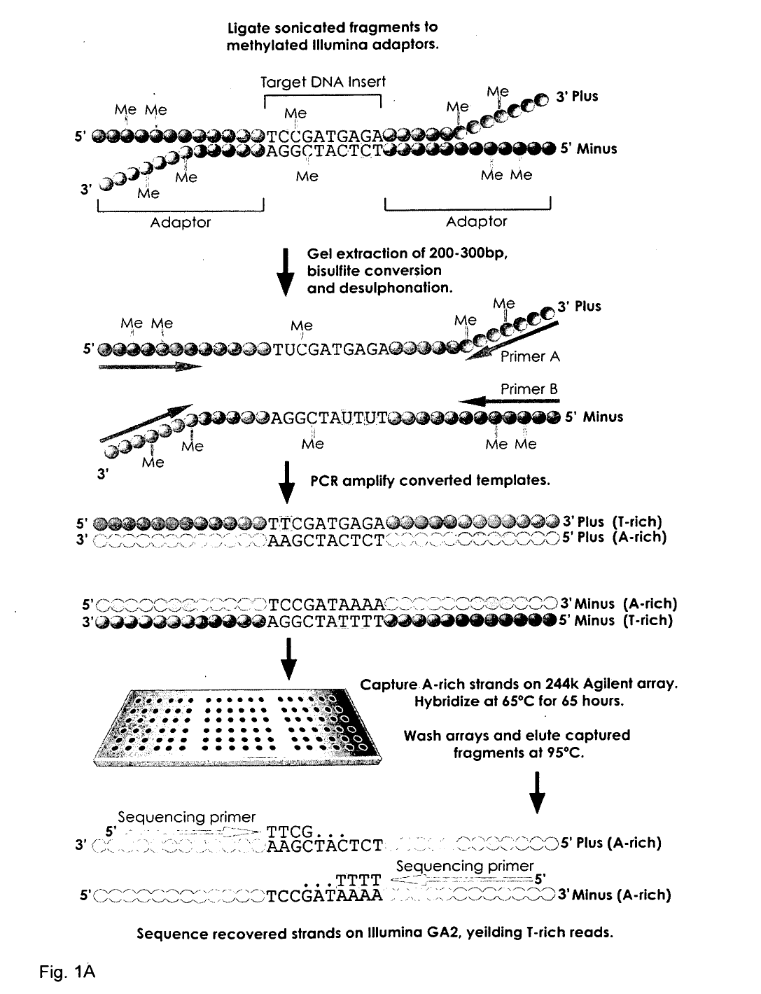

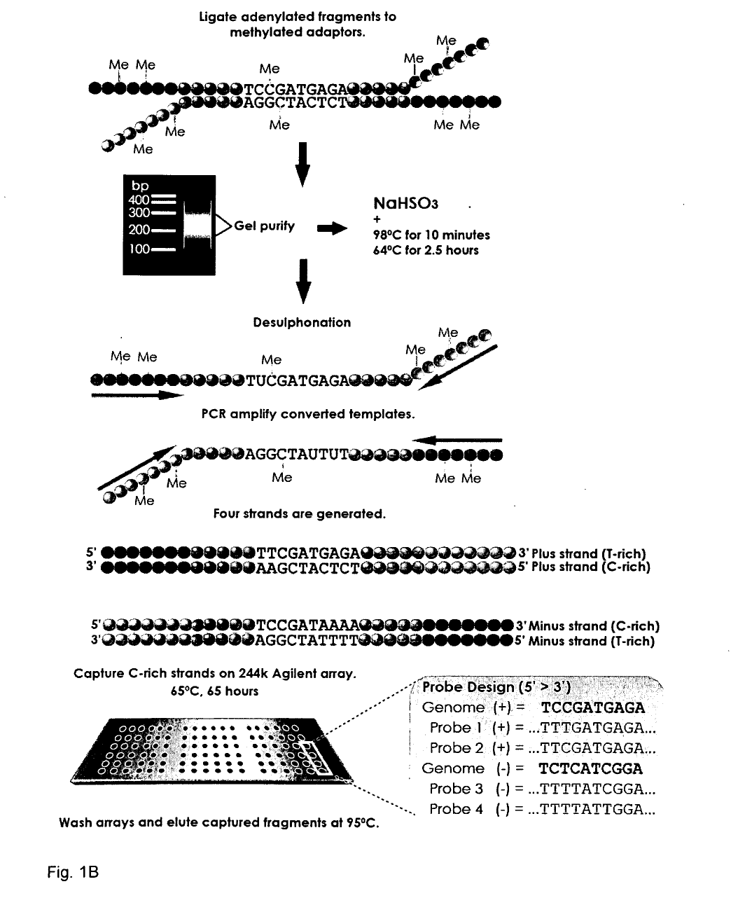

The primary ligated material was bisulfite converted and amplified using common primer sequences present on the adapters. Amplification of the bisulfite treated DNA results in the formation of a complementary strand, the sequence of which is dependant on the methylation status of the genomic sample, and is thus unique from the original pre-bisulfite treated complementary strand. The bisulfite treatment and subsequent amplification therefore results in the formation of 4 unique nucleic acid strands, thus increasing DNA complexity. (FIG. 1A-B).

Two strands are derived from the original plus and minus strands of the genome. Since these were treated with bisulfite, they are depleted of cytosine, and are designated as the T-rich strands. The other two strands are complements of the treated genomic strands and are designated as the A-rich strands (FIG. 1A)

### Example 3

The converted, adaptor-ligated fragments were PCR enriched using paired-end adaptor-compatible primers 1.0 and 2.0 (Illumina®) and Expand High Fidelity^{PLUS} PCR System (Roche®), a specialized polymerase capable of amplifying the highly denatured, uracil-rich templates, which can sometimes be problematic.

d. CpG Island Array Capture of Bisulfite Treated DNA

Among relevant targets of DNA methylation in mammalian genomes are the CpG islands, defined for annotation in the UCSC browser (http://genome.ucsc.edu) as a sequence of >200 bp with a GC content greater than 50% and with significant enrichment in CpG dinucleotides [28]. Of the more than 28,000 annotated CpG islands, 324 randomly selected examples were used in the study ranging from approximately 300 to 2000 bp in size representing 258,895 bases of genomic space and 25,000 CpG sites (−0.1% of all CpG sites in the genome). The set was distributed among all autosomes and chromosome X, including 170 islands located within 1500 bp of an annotated protein coding genes as well as 154 islands outside of annotated promoter regions, both intra- and intergenic.

In principle, it is possible to capture any of the four converted single strands resulting from PCR of bisulfite-treated DNA (see FIG. 1A-B). In the case of symmetric CpG methylation, these four strands would contain the same information since both strands of the CpG position would have been methylated. Therefore the methylation status of each CpG position may be assessed independently four times. Accordingly, the capture of one of the four products should allow inference of a complete methylation map.

However, there have been reports of asymmetric (non-CpG) methylation in some mammalian cell type [30-32]. Although these were not the focus of the study, detecting such modifications would require separate analysis of products of both genomic strands. Capturing more than one strand would also increase coverage and thus confidence in determining methylation states, but the trade-off would be a reduction in the overall genomic extent that could be tiled on an array of a given diversity. In this example, the complements of the treated genomic strands, both the plus and minus strands, “A-rich derivatives” were captured (FIG. 1A). However, depending upon the biological question, capture of one strand would certainly be sufficient.

Previous studies have quantified the effect of mismatches on hybridization to 60 nucleotide probes printed on 244K Agilent® custom arrays [33,34], the same selection substrate, which we now use routinely in our capture studies [48]. These reports suggest that up to 6 distributed mismatches are tolerated without a substantial impact on hybridization efficiency. Previous studies also indicated that the presence of Single Nucleotide Polymorphisms (SNPs) did not impact the efficiency of capture [25]. Therefore some uncertainty in the sequence of the A-rich target strands could be tolerated.

To capture the “A-rich strands” resulting from the PCR of bisulfite-treated DNA, two sets of capture probes corresponding to the plus (+) and minus (−) strand of the target DNA were designed. Each probe set consisted of a two-probe subset. The first probe in a given probe set correspond to sequences of a single-stranded DNA segment that assumes all CpGs remained unmethylated, such that every cytosine residue is substituted for thymine in the first probe. The second probe in a given probe set correspond to sequences of a single-stranded DNA segment that assumes all CpGs were methylated, such that every cytosine other than the cytosine residue of the CpG dinucleotide, is substituted for a thymine residue in the second probe. Thereby generating a total of four capture probes (FIG. 1A).

To capture the “T-rich strands” resulting from the PCR of bisulfite-treated DNA, one would design probe sets which are: complements of the probes used to capture the “A-rich strands.”

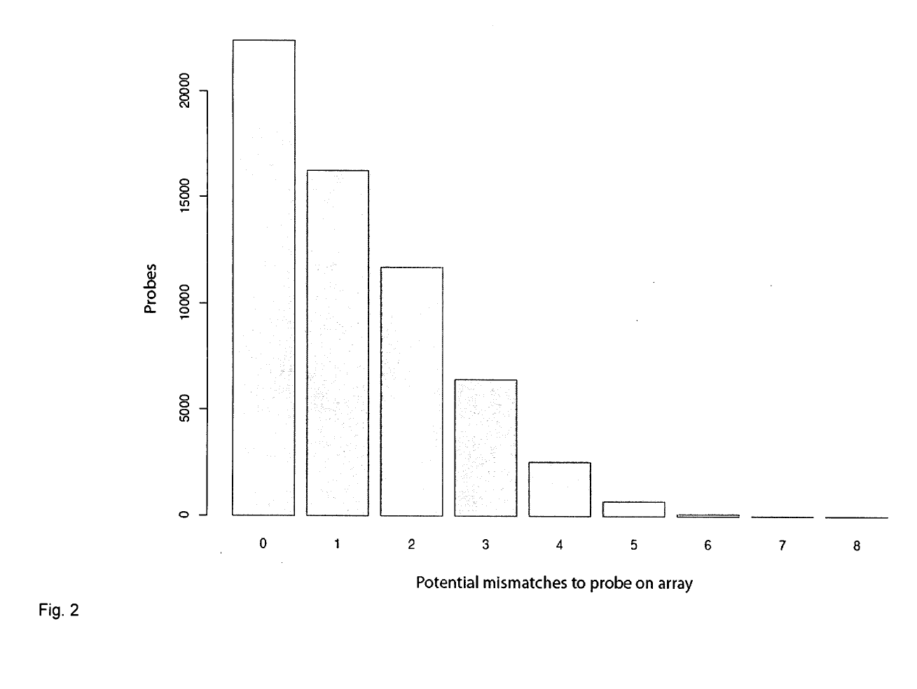

Thus, even with a completely random pattern of CpG methylation, only half of the CpG sites within a given probe would contribute a mismatch. The mean number of CpGs within probes to our 324 randomly selected CpG islands is 4.68, and the maximum in any probe is 15. Thus, the vast majority of probes are well within the predicted margin of safety for efficient capture (FIG. 2). The overall extent of the mismatch problem is likely to be much lower than this theoretical maximum since most studies find a local correlation between the methylation states of neighboring CpGs.

### Example 4

A custom Agilent® microarray with 244K probes was printed in which selected regions were tiled at a 6-base interval. Since four probes overlap each site, this allowed a total of −300 kB to be targeted for capture. Bisulfite converted SKN-1 and MDA-MB-231 libraries were hybridized to the capture arrays using the standard Agilent® Array CGH buffer system.

There are known repetitive sequences in the human genome annotated as repeat masked regions. When selecting probes to capture region of the genome, probe pairs are chosen every N bases where N can be 1 to 30 or more. Preferably, a probe pair is selected every 6 or 9 bases of the genome unless the probe sequence is more than 50% in a repeat masked region.

Briefly, 20 μg of bisulfite treated DNA was hybridized to custom Agilent® 244K microarrays according to the Agilent® aCGH protocol with several modifications. Firstly, in addition to 20 μg sample DNA, 50 ug human cot-1 DNA (Invitrogen®) and Agilent® blocking agent, Agilent aCGH/ChIP Hi-RPM hybridization buffer was supplemented with approximately 1 nmol each of four blocking oligonucleotides: BO1[5′AATGATACGGCGACCACCGAGATCTACACTCTTTCCCTACACGACGCTCTTCCGAT CT3′] (SEQ ID NO: 1), BO2 [5′ CAAGCAGAAGACGGCATACGAGATCGGTCTCGGCATTCCTGCTGAACCGCTCTTCCGATCT3′] (SEQ ID NO: 2), BO3 [5′AGATCGGAAGAGCGTCGTGTAGGGAAAGAGTGTAGATCTCGGTGGTCGCCGTATCATT3′] (SEQ ID NO: 3) and BO4 [5′ AGATCGGAAGAGCGGTTCAGCAGGAATGCCGAGACCGATCTCGTATGCCGTCTTCTGCTTG 3′] (SEQ ID NO: 4) before denaturing at 95° C. The samples were hybridized at 65° C. for 65 h in a rotating microarray oven (SciGene®). After hybridization, the arrays were washed at room temperature for 10 min with aCGH wash buffer 1 (Agilent®) and washed with aCGH wash buffer 2 (Agilent®) at 37° C. for 5 min. Slides were briefly dried at low speed in a slide rack using a centrifuge with a microplate adaptor. Captured bisulfite-treated DNA fragments hybridized to the arrays were immediately eluted with 490 ul nuclease-free water at 95° C. for min in the rotating microarray oven. The fragments were removed from the chamber assembly using a 28G syringe (BD®). Samples were subsequently lyophilized and resuspended for amplification. Five 18-cycle PCR amplifications were performed in parallel for each eluate using Phusion HF PCR master mix (Finnzymes®). Following amplification, the PCR reactions were pooled and purified on Qiagen® purification columns.

Microarrays for use in the present invention are known in the art and consist of a surface to which probes can be specifically hybridized or bound, preferably at a known position. Each probe preferably has a different nucleic acid sequence. The position of each probe on the solid surface is preferably known.

To manufacture a microarray DNA probes are attached to a solid support, which may be made from glass, plastic (e.g., polypropylene, nylon), polyacrylamide, nitrocellulose, or other materials, and may be porous or nonporous. A preferred method for attaching the nucleic acids to a surface is by printing on glass plate.

A second preferred method for making microarrays is by making high-density oligonucleotide arrays. Techniques are known for producing arrays containing thousands of oligonucleotides complementary to defined sequences, at defined locations on a surface using photolithographic techniques for synthesis in situ.

In principal, any type of array, for example, dot blots on a nylon hybridization membrane, could be used, although, as will be recognized by those of skill in the art, very small arrays will be preferred because hybridization volumes will be smaller. Presynthesized probes can be attached to solid phases by methods known in the art.

Nucleic acid hybridization and wash conditions are chosen such that the sample DNA specifically binds or specifically hybridizes to its complementary DNA of the array, preferably to a specific array site, wherein its complementary DNA is located, i.e., the sample DNA hybridizes, duplexes or binds to a sequence array site with a complementary DNA probe sequence but does not substantially hybridize to a site with a non-complementary DNA sequence. As used herein, one polynucleotide sequence is considered complementary to another when, if the shorter of the polynucleotides is less than or equal to 25 bases, there are no mismatches using standard base-pairing rules or, if the shorter of the polynucleotides is longer than 25 bases, there is no more than a 5% mismatch. Preferably, the polynucleotides are perfectly complementary (no mismatches). It can easily be demonstrated that specific hybridization conditions result in specific hybridization by carrying out a hybridization assay including negative controls.

Arrays containing double-stranded probe DNA situated thereon are preferably subjected to denaturing conditions to render the DNA single-stranded prior to contacting with the sample DNA. Arrays containing single-stranded probe DNA (e.g., synthetic oligodeoxyribonucleic acids) need not be denatured prior to contacting with the sample DNA.

Optimal hybridization conditions will depend on the length (e.g., oligomer versus polynucleotide greater than 200 bases) and type (e.g., RNA, DNA) of probe and sample nucleic acids.

Hybridization to the array may be detected by any method known to those of skill in the art, including but not limited to detection of fluorescently labeled sample nucleotides or sequencing the hybridized sample.

e. Sequencing of Capture of Bisulfite Treated DNA

The captured and amplified DNA was quantified using the Nanodrop® 7500 and diluted to a working concentration of 10 nM. Cluster generation was performed for samples representing each array capture in individual lanes of the Illumine® G2 flow cell. An adapter-compatible sequencing primer (Illumine®) was hybridized to the prepared flow cell and 36 to 50 cycles of base incorporation were carried out on the Illumine® G2 genome analyzer.

### II. Mapping Bisulfite Treated Reads

Mapping short sequence reads requires identifying the genomic location at which the reference sequence most closely matches that of the read. A small number of mismatches are typically allowed, and when the best match for a given read occurs at two distinct locations, that read is said to map ambiguously. Bisulfite treatment presents a significant challenge to mapping short reads because the inherent information content of converted DNA is reduced. When sequencing the complement strand of a captured A-rich strand, an observed T in a read may map to a T or a C in the reference genome.

An algorithm was developed for rapidly mapping bisulfite treated reads while accounting for both the C to T conversion at unmethylated cytosines and for the information retained at cytosines protected from conversion by methylation. We follow the conventional mapping strategy of first excluding much of the genome from consideration by requiring candidate mapping locations to match exactly with a subset of the read.

The algorithm is based on RMAP [49] and follows the conventional strategy used in approximate matching. First, an “exclusion” stage was used requiring candidate mapping locations to have an exact match to the read in a specific subset of positions (“seed” positions). Because the exclusion stage used exact matching, it assumed all Cs in both read and genome sequences have been converted to T. This assumption resulted in a substantial loss of efficiency to the exclusion, and tiled seeds were designed to compensate for this loss. This had the effect of the multiple filtration strategy of [50] but permitted a highly efficient implementation. In contrast with mapping methods that preprocess the genome, this strategy required relatively little memory and was therefore appropriate for use on nodes of scientific clusters commonly used for analysis of sequencing data.

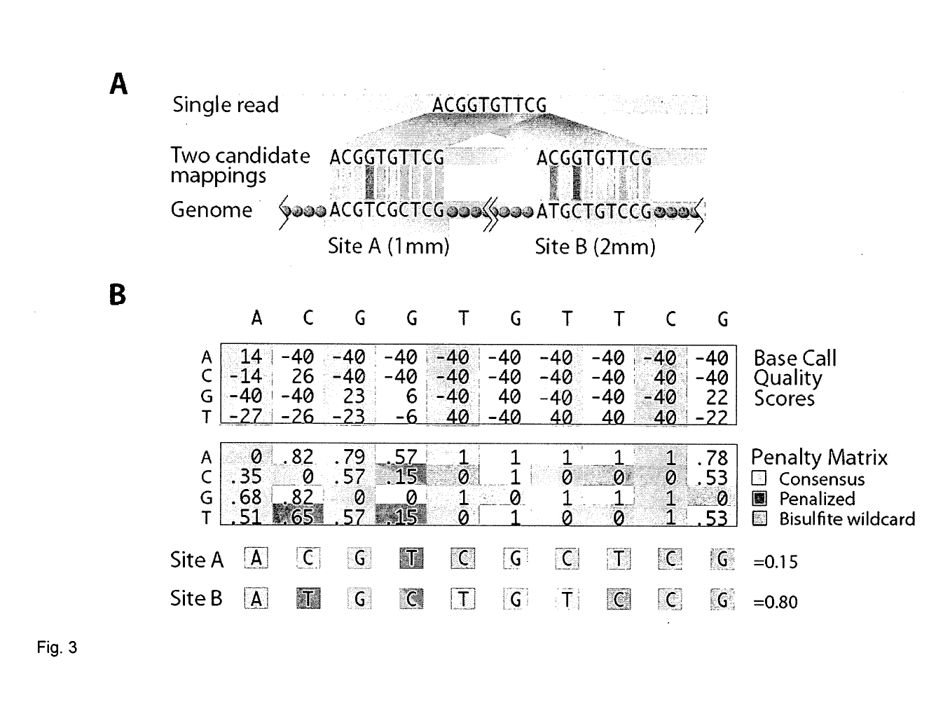

Stronger exclusion criterion was implemented to optimize the mapping algorithm for bisulfite-treated DNA. This compensated for the larger number of spurious matches that occur because, during the exclusion stage, one must assume a reduction in information content to 3 bases. For the subsequent full comparison stage, wildcard matching was conducted allowing any T in reads to match with either a C or T in the genome (FIG. 3A).

The algorithm was also designed to take advantage of quality scores generated during sequencing by assigning fractional mismatch penalties based upon the certainty of a base call and by taking into account the fact that a large fraction of C's are converted to T's (FIG. 3B). For example, in the comparison of Site A versus Site B in FIG. 3, a clear high quality call of G, C or A resulted in a strong penalty for any mismatch. A less high quality call of G, C or A provided an intermediate penalty whose quantitative weight was a function of the individual probabilities of each alternative call (e.g. FIG. 3B, Site B, position 2). Since bisulfite converted DNA was being sequenced, potential T calls had an equal probability of originating from a genomic T or C. Thus, for cases in which there was a higher probability of a T call than a C call, the lower mismatch penalty for T was also assigned to C (e.g., FIG. 3B, site B, position 4). A full description of the algorithm is given Examples 5 and 6, along with a comparison of mapping performance for reads generated from bisulfite treated and non-treated DNA.

### Example 5

### Mapping Bisulfite Treated Reads

Two algorithms to map reads sequenced after the DNA has been treated with bisulfite, which converts unmethylated cytosines into thymidine. The difference between the two algorithms is in how mappings are evaluated: RMAPBS evaluates mappings using mismatch-counts, and RMAPBSQ program incorporate base-call quality scores for greater accuracy. In both cases, the strategy is one of matching reads to the genome using a wildcard that allows Ts in reads match Cs in the genome without penalty. This strategy differs from that of converting all Cs in reads and reference genome into T, which effectively reduces the sequence alphabet to a size of 3.

Importantly, RMAPBS and RMAPBSQ are sufficiently fast and have a sufficiently small memory footprint that they can be used effectively on mammalian genomes with commodity hardware, such as the scientific cluster nodes presently used for post sequencing data processing.

Reads were mapped with the RMAPBS program, freely available from the authors as Open Source software under the GNU Public License. A suite of software tools was implemented (also available from the authors) to estimate methylation frequencies of individual CpGs, tabulate statistics about methylation in each CpG island, and compile diagnostic statistics about bisulfite capture experiments. Details are provided below. Enrichment was computed as (reads mapped to genome/reads overlapping target regions)/(length of target regions/length of genome). The bisulfite nonconversion rate was estimated by the number of cytosines in read sequences not followed by a guanine that also mapped to non-CpG cytosines in the reference genome divided by the number of non-CpG cytosines in the reference genome corresponding to each read sequence. Counts of each residue of all reads mapped to target regions were tabulated for both strands of the reference genome. Coverage statistics and graphs of genome regions were computed using these tabulations.

Below describes in greater detail how these algorithms were implemented, explaining the use of seeds for exclusion, and then the flow of control in the algorithms. Also presented is an analysis of the unmappable regions resulting from the loss of information due to bisulfite treatment.

### Example 5a

### Mapping Bisulfite Treated Reads: Filtration and Seed Selection

Most mapping algorithms abstract the read mapping problem as an approximate string matching problem, where the goal is to find occurrences of short patterns (i.e. the reads) within a longer text (i.e. the reference genome). In the case of Solexa® read mapping the number of patterns can be immense (10-100 million reads per experiment; some or all lanes from a single flow-cell), and the human genome is roughly 3G bases of possible matching locations. For this reason, despite having relatively low asymptotic complexity, approximate matching algorithms must be highly efficient to be practical for mapping Solexa® reads. It has long been known that the best techniques for exact string matching can be used to speed-up approximate matching through various techniques commonly referred to as “exclusion” methods. Gusfield gives an in-depth discussion of such techniques [35]. The basic idea is as follows: whenever two sequences match approximately (i.e. with fewer than a specified number of mismatches) then some “part” of them must match exactly. Various results have been derived about conditions on the parts that must match exactly, and this remains an active area of research. A frequent procedure is to scan the larger text with part of the pattern. Locations In the text where that part matches exactly are called “hits” and the area surrounding each hit is examined more closely to determine if it matches well with the entire pattern.

RMAPBS and RMAPBSQ use the idea of “layered seeds”, which is similar to multiple filtration [36]. Seed structures indicate sets of positions in the reads that are required to match the genome exactly at any location where the read can map. Two distinct sets of seed structures are obtained such that if there is an approximate match, then each set of seed structures will contain at least one structure indicating positions that match exactly between the read and the genome. The two distinct sets of seed structures are combined creating a new set of seed structures corresponding to each pair of structures from the two initial sets. The combined (or layered) seed structures are more numerous, leading to an increased number of scans of the genome. However, these layered seeds are more specific, and therefore each scan excludes more full comparisons and is more efficient.

The following diagram illustrates layering of seed structures from two sets, producing a third set of seed structures:

$$\{ \begin{matrix}{a}_{1} : 111100000000 \\ {a}_{2} : 000011110000 \\ {a}_{3} : 000000001111\end{matrix} \} + \{ \begin{matrix}{b}_{1} : 100100100100 \\ {b}_{2} : 010010010010 \\ {b}_{3} : 001001001001\end{matrix} \} = \{ \begin{matrix}{a}_{1} {b}_{1} : 111100100100 \\ {a}_{1} {b}_{2} : 111110010010 \\ {a}_{1} {b}_{3} : 111101001001 \\ {a}_{2} {b}_{1} : 100111110100 \\ {a}_{2} {b}_{2} : 010011110010 \\ {a}_{2} {b}_{3} : 001011111001 \\ {a}_{3} {b}_{1} : 100100101111 \\ {a}_{3} {b}_{2} : 010010011111 \\ {a}_{3} {b}_{3} : 001001001111\end{matrix} \}$$

Three sets are presented, the third being obtained by layering the first two sets. The 1s in each seed structure indicate positions the structure requires to match between two sequences for a full comparison of the sequences to be triggered. Each of these seed structure sets can be used to identify matching between 12 bp sequences having up to 2 mismatches. The set resulting from layering has a larger number of structures but each structure specifies a greater number of positions that must match between the two sequences, and therefore results in fewer random “hits” when scanning the genome.

As each chromosome is scanned a 32 bp segment of the genome is maintained in a machine word (an unsigned 64-bit integer) in 2-bit format (i.e. A=00, C=01, G=10, T=11). This sequence can be treated as an unsigned integer and several operations may be applied to it in meaningful ways. Another value maintains the seed structure (statically) as each chromosome is scanned. If position i is in the current seed structure (indexed from 0), then bits 2i and 2i+1 will be set to 1 in the value representing the structure, and all others will have a value of 0. The operation of taking a bit-wise “and” of the value representing the genomic segment and the value representing the seed structure is called applying the seed structure to a sequence, and the result of this operation has an important property: If sequence s₁ and sequence s₂ are identical at positions in a seed structure, then the value obtained by applying the seed structure to the 2-bit representation of s1 will be identical to the value obtained by applying the seed structure to s₂.

As each seed structure is processed, a hash table is constructed to index all the reads based on the result of applying the structure to the read sequences. In our implementation collisions are resolved by chaining, and each chain corresponds to the set of reads having a specific sequence of bases at the positions specified by the seed structure. To hash values that result from applying a seed structure to a 2-bit representation of a sequence we use the modulo function of the size of the hash table, which is maintained at sizes that are prime numbers.

### Example 5b

### Mapping Bisulfite Treated Reads: Organization of the RMAPBS Program

The description here refers directly to RMAPBS but also applies to RMAPBSQ. Important differences will be indicated. When RMAPBS begins there are several initial processing steps taken before the work of the algorithm commences. Read sequences (given in FASTA format) are loaded and pre-processed to remove low-quality reads. Each read is converted to an encoding that allows more efficient comparison. Next the set of seeds is constructed based on parameters supplied by the user (See Example 5a). Data structures are also initialized to retain mapping results as the genome is scanned, keeping track of scores, mapping locations and mapping uniqueness/ambiguity.

Scanning chromosomes. This procedure operates on (1) a single chromosome (i.e. contiguous portion of the reference genome), (2) a fixed set of reads and (3) a single seed structure. The procedure is very simple when described in terms of basic operations on a few objects. Pseudocode is given in Table 1. In the pseudocode objects and variables are italicized. The Seed initialized in statement 1 is a sliding window of genomic sequence with size equal to the width of reads. The representation used is one that allows the seed to be updated quickly and to be hashed efficiently. The GenomeRead also initialized in statement 1 is another representation for the sliding window of genomic sequence. This representation is designed to efficiently implement the full comparison between a read and a portion of the genome at those locations when a hit is encountered. Presently this implementation is the same implementation used for reads, but there is not perfect symmetry between genomic sequence and read sequence when comparing the two, so it is not necessary that the representations be the same.

TABLE 1
Algorithm 1 Pseudocode for inner loops of RMAPBS
algorithm, denoted scan chromosome in Algorithm 2.
The input is a chromosome C, a seed structure
(implicitly used below in statement 6; see text),
the hash table SeedHash to index the reads according
to their seed sequences, and some structure to
maintain attributes of reads (such as BestScore).

```
  1: initialize Seed and GenomeRead
  2: for each position i in chromosome C do
  3:  Cᵢ ← the base at position i of C
  4:  update Seed by shifting and appending base Cᵢ
  5:  update GenomeRead by shifting and appending base Cᵢ
  6:  CandidateReadSet ← SeedHash(hash_value(Seed))
  7:  for each Read ∈ CandidateReadSer do
  8:  score ← calculate_score(Read. GenomeRead)
  9:  if score < BestScore(Read) then
10:  if score = BestScore(Read) then
11:  UniqueMatch(Read) ← False
12:  end if
13:  BestScore(Read) ← score
14:  MatchLocation(Read) ← i
15:  end if
16:  end for
17: end for
```

The loop entered in statement 2 iterates over positions in the chromosome. Statements 4 and 5 update the Seed and GenomeRead objects at each iteration of the loop so that they represent the sequence in the genomic interval ending at the current genomic location. In statement 6 the Seed is converted into a numeric value using the function hash value. This value is used in the same statement to obtain the (possibly empty) set of reads, denoted CandidateReadSet, that must be verified by a full comparison the current genomic sequence represented by GenomeRead. The SeedHash is accessed using the hash value obtained from Seed. The values stored in SeedHash can be thought of as sets of reads. The loop entered in statement 7 tests each Read in the CandidateReadSet to determine if it maps at the current genomic location. The match score is calculated in statement 8, and is the number of mismatches between the Read and the GenomeRead, allowing a T in the Read to match a C in the GenomeRead. The comparison is done differently in RMAPBSQ. If the resulting score satisfies the requirements for a unique match it is recorded along with the current genomic location as the mapping location of the Read (statements 13 and 14). If the score is not better than the current BestScore for the Read, then the read is marked as ambiguous (statement 11).

Assuming fixed input to the scanning procedure, aspects that most influence efficiency are the hashing in statement 6, the full comparisons in statement 8 and the way in which the Seed and the GenomeRead are updated. Implementing these details in different ways may improve the efficiency of RMAPBS in terms of speed, memory use or both.

Outer loops. Our strategy of using multiple seed structures (Example 5e. Filtration and seed selection) requires the entire genome to be scanned using each seed structure. Each chromosome was also scanned separately, for two fairly arbitrary reasons: (1) no read can map with part in one chromosome and part in another, and (2) the average memory per core or processor in many scientific clusters is not large enough for the entire genome to reside in memory as one copy per core. Clearly both of these issues could be handled in multiple ways more conducive to overall efficiency. Our current implementation of the outer loops in RMAPBS is given as pseudocode in Table 2.

TABLE 2
Algorithm 2 Pseudocode for outer loops of RMAPBS
algorithm. The input is a set of reads (denoted R), the set of
chromosomes G from the reference genome. The set of seed
structures used is denoted S.

```
  1: for each seed s ∈ S do
  2:  build SeedHash from the reads in R using seed s
  3:  for each chromosome C ∈ G do
  4:  scan_chromosome(SeedHash. C)
  5:  C ←reverse_complement(C)
  6:  scan_chromosome(SeedHash, C)
  7:  end for
  8:  remove perfect scoring ambiguously mapping reads from R
  9: end for
10: remove any ambiguously mapping reads from R
11: output unambiguous mapping locations
```

Implementation. RMAPBS and RMAPBSQ are implemented in C++ and require a sufficiently recent compiler to have the TR1 library available (e.g. GCC 4.2). These programs also require that the GNU popt library be available for handling command-line arguments.

### Example 5C

### Mapping Bisulfite Treated Reads: Use of Quality Scores

Any scores representing logarithms of likelihood ratios for the accuracy of base calls can be provided to our method, but the description here assumes quality scores as produced by the Solexa® software.

Each position in a read is assigned four quality scores, one for each base. These qualities reflect the relative probabilities for the actual identity of the base sequenced at that position. The consensus sequence consists of the bases having the highest quality scores at each position. Mapping methods have traditionally scored mappings by counting mismatches between the consensus sequence and corresponding positions in the genomic sequence. Our method uses quality scores to weigh mismatches so that mappings with non-consensus bases in the genomic sequence are penalized less when the quality score for those bases are higher at the appropriate positions. In this way we penalize less for mismatches at positions that were less confidently called, especially when the non-consensus base has quality close to that of the consensus base.

The Solexa® pipeline produces quality scores in the range −40 to 40, with at most one base having a score greater than 0 at any position. If a consensus base receives a perfect quality of 40, then the remaining three bases will be assigned −40, and a mismatch at that position can be equated with a difference of 80 in the quality score. More generally, if the consensus quality at a position is c, then for any base at that position, if the quality score for that base is b then the penalty associated with that base is (c−b)/80. In particular, the penalty for the consensus base is always 0, and when the consensus base has a quality score of 40 the penalty for all other bases is 1.

When mapping bisulfite treated reads, the penalty for a C is modified to take the penalty for a T at the same position if that penalty smaller. This adjustment is made regardless of which base is the consensus, so that if the consensus base is A, for example, and the second best scoring base is T, then an alignment containing a C at that position in the genome will receive the same score as if a T were at that position.

### Example 5d

### Mapping Bisulfite Treated Reads: Bisulfite Dead-Zones and Limits of Mapping

Genomic “dead zones” are locations in the genome where no read can map uniquely because the sequence starting at that location (i.e. a k-mer, when considering reads of width k) is identical to the sequence at some other location in the genome. Regardless of how well a read matches one of these sequences, it will match the other equally well. In particular, when reads are of width k, any deadzone that is larger than k−1 bases will contain bases over which no read can map uniquely.

When reads are treated with bisulfite the loss of information resulting from the C→T conversion at each unmethylated C causes an increase in the number of dead-zones. These “bisulfite-specific” deadzones will differ between strands, and also between the scenarios of no methylation versus full methylation at CpGs. A dead-zone, assuming no methylation, is any genomic location on a specified strand where the k-mer appearing at that location on the specified strand is identical to a k-mer appearing elsewhere in the genome on either strand when all Cs have been converted to Ts. A dead-zone assuming methylation at every CpG is any genomic location on a specified strand where the k-mer appearing on the positive strand is identical to a k-mer appearing elsewhere on either strand when all Cs have been converted to Ts except those preceeding a G. By exhaustive analysis of the genome, we identified all bisulfite specific dead-zones for both methylation assumptions (i.e. no methylation and total methylation) for a read width of 36. The results are presented in Table 3.

TABLE 3
Mapping Dead Zones

| | Total | | | | | | |
|---|---|---|---|---|---|---|---|
| Regions | size | Non-BS | Methylation | Positive | Negative | Intersection | Union |
| Genome | 2858006286 | 294245416 | 0% | 541315508 | 541374827 | 451774737 | 743128141 |
| | | | 100% | 432727298 | 432727298 | 349469459 | 621914024 |
| Target | | | 0% | 23423 | 23473 | 20065 | 28897 |
| | | | 100% | 12977 | 13074 | 11413 | 15200 |

Bisulfite dead-zones in hg18 for a read width of 36. Target regions refer to the 324 randomly selected CGIs. Total dead-zone sizes are accurate to within less than 10 Kbp. Total size of the genome does not include unknown portions of the genome (e.g. centromeres).

The following experiments were conducted to get a more realistic view of the limits of mappability and how they affect projects such as the one we describe. A comparison of the wildcard mapping strategy with one of mapping under the reduced (3 base) representation was performed. 2M reads of length 36 were simulated by randomly sampling a 36-mer from the genome that contains a CpG. The simulated reads were then treated with bisulfite, converting each C to a T, except Cs at CpGs were kept unconverted with probability 0.9 (to simulate a methylation probability of 0.9 genome-wide). The RMAP program was applied to map all the simulated reads after remaining Cs were converted to Gs. The genome was supplied in a form with each C converted to T, and each chromosome was duplicated so an additional copy of each chromosome was also scanned with each G converted to an A (so simulated reads derived from the negative strand could be mapped). The RMAPBS program was applied to the original simulated reads using the original genome. We conducted two such simulations, one with up to 4 simulated sequencing errors (placed uniformly at random in the reads), and another with up to 2 simulated sequencing errors. Mapping was done with parameters that guarantee full M sensitivity to 3 mismatches in the case of up to 4 simulated sequencing errors per read.

Using RMAPBS, 1337997 reads mapped uniquely allowing up to 4 errors and 593199 mapped ambiguously. Using the reduced representation, 1258235 mapped uniquely, with 684943 mapping ambiguously. Requiring that reads map uniquely back to the genomic location from which they derived, RMAPBS mapped 1213236 uniquely, compared with 1103573 for the other strategy. This is an increase of 9.9% when using RMAPBS.

### Example 6

### Calling CpGs and CpG Island Methylation Status

The basic diagnostic statistic with respect to individual CpG methylation for the experiment is the number of CpGs for which a confident call can be made. The distribution of methylation proportions for individual CpGs in a given biological sample can be used as a gross characterization of methylation states for that sample. Although it may not be biologically appropriate to say that a CpG island is methylated or unmethylated, in order to compare overall amounts of methylation at specific islands between samples we developed a method to estimate the frequency of methylation for a particular CpG island in a sample, and classify the most extreme cases as methylated or unmethylated.

### Example 6a

### Calling CpGs and CpG Island Methylation Status: Calling Methylation at Individual CpGs

The method for calling methylation at a CpG classifies each CpG as either methylated, unmethylated or partially methylated when sufficient data exists. The raw statistic we use is the frequency of unconverted Cs in reads mapping over the CpG in question. Methylation is assumed to be symmetric, so unconverted Cs covering a CpG mapping to the negative strand are counted along with those on the positive strand. Reads having a base other than a T or a C mapping over the C of a CpG are excluded from the analysis. We therefore begin with a number n of reads mapping over the CpG on either strand and having either a C or T at the appropriate position. Let k be the number of those reads having a C at the appropriate position, counting the number of reads in which the C is unconverted by the treatment. We define the value p as the proportion methylated for a given CpG, indicating the proportion of cells in a sample in which that CpG is methylated. We use the \hat{p}=k/n as an estimator for p.

We call the methylation state of a CpG using confidence intervals on p given the observed proportion \hat{p} and number of observations n. A value is specified for a, and another value ω for the width of the (1−α)-confidence interval for p. We take α=0.1 and ω=0.25. If the difference between the upper and lower confidence bounds for p given \hat{p} and n is less than ω, then we say that the estimate \hat{p} of p is confident. Further, if the lower confidence bound is greater than (1−ω), then we call the CpG methylated; if the upper confidence bound is less than ω, then we call the CpG unmethylated. This scheme assigns each CpG to one of four classes: unmethylated (U), methylated (M), partially methylated (P; confident but neither U or M) and not called (N). We calculate confidence intervals for p using the formula of [37]. For given values of n and \hat{p}, the upper and lower bounds on the (1−α) confidence interval for p are

$$\frac{\hat{p} + \frac{1}{2 n} {z}_{1 - α / 2 }^{2} \pm {z}_{1 - α / 2} \sqrt{\frac{\hat{p} ( 1 - \hat{p} )}{n} + \frac{{z}_{1 - α / 2}^{2}}{4 n}}}{1 + \frac{1}{n} {z}_{1 - α / 2}^{2}} ,$$

where z_{1-α/2} is the (1−α/2) quantile of the standard normal distribution.

To avoid bias, when comparing the frequency of methylation proportions, we require that each CpG considered have the number of observations sufficient to result in a confident call at a proportion of 0.5, which requires the most observations of any proportion for a given width of confidence interval. For a α=0.1 and ω=0.25, the required number of reads is 41.

### Example 6b

### Calling CpGs and CpG Island Methylation Status: Calling Methylation State of CpG Islands

Here we describe how we estimate the overall frequency of methylation at CpGs In a CpG island. This frequency can be understood by analogy with the following experiment: a single chromosome is sampled containing the CpG island of interest, and the proportion of CpGs in the sequence that are methylated is observed. The proportion is therefore a proportion of CpGs in an island, but we estimate this proportion using all of the reads mapping into that island, which requires us to account for the fact that different CpGs in the island will have a different number of reads mapping over them. We use a Monte-Carlo simulation to estimate the methylation frequency empirically. This method assumes that methylation events at distinct CpGs in an island are independent. Although methylation events likely have strong dependencies, we believe assuming independence is more prudent at present than using potentially incorrect assumptions about specific kinds of dependencies. In addition, we only consider CpG islands for which at least 90% of CpGs are covered by at least one read to ensure that our results reflect the entire island and not some small portion thereof. All frequencies reported for islands were therefore obtained by using the number of covered CpGs in an island as the total number of CpGs in that island.

For a particular CpG island, let X={X₁, . . . , Xₙ} be indicator variables with Xᵢ=1 exactly when the i^{th} CpG is methylated. The sum M=ΣᵢXᵢ therefore gives the frequency of methylation in the CpG island, and it is this sum we wish to estimate. Let p+{pᵢ, . . . pₙ} be the unknown vector of methylation frequencies at the n individual CpGs in the island; pᵢ gives the probability that the i^{th} CpG is methylated in a copy of the sequence. Note that if p were known, the distribution of M could be easily determined.

The data available for understanding the sum M are the counts of reads mapping over each CpG. Denote by aᵢ the number of reads mapping a C over the i^{th} CpG, and let bᵢ count the number of Ts mapping over the i^{th} CpG. As in Section 2.1, we estimate \hat{p}ᵢ=aᵢ/(aᵢ+bᵢ). Given these observations about methylated and unmethylated reads, Pr(pᵢ=\hat{p}ᵢ|aᵢ, bᵢ)˜Beta (aᵢ, bᵢ).

In practice we add a value of 1 to each aᵢ and bᵢ assuming a uniform prior over possible methylation frequencies at a CpG. We remark that this prior could be informed by biological considerations. In our simulation, each sample consists of two steps. First, we generate \tilde{p}={\tilde{p}ᵢ, . . . , \tilde{p}ₙ} by drawing the individual \tilde{p}ᵢ from the Beta (aᵢ, bᵢ) distribution. Second, we use \tilde{p} to generate a sequence of methylation events \tilde{X}={\tilde{X}ᵢ, . . . , \tilde{X}ₙ} by drawing \tilde{X}ᵢ from the Binomial (\tilde{p}ᵢ) distribution. The sum \tilde{M}=Σᵢ\tilde{X}ᵢ is maintained as the sample value. These steps are repeated to construct an empirical distribution. For our results, 100,000 samples were taken.

From the empirical distribution the mean methylation frequency is used to estimate \tilde{M} along with the upper and lower (1−α) confidence bounds for M. Similar to our method for individual CpGs, we use the confidence bounds for M to classify CpG islands according to overall methylation. Values for α and ω are used with the same meanings and values as for individual CpGs: confident estimates of M require the (1−α) confidence interval to span at most ω, if the upper bound is at most ω the island is called unmethylated, and if the lower bound is at least (1−ω) the island is called methylated.

### III. In Situ Capture Enriches Targeted CpG Islands

The mapping algorithm was used to assign genomic locations to sequence reads from captured bisulfite-treated material and to determine whether the method successfully enriched targeted regions from converted libraries. 20,002,407 raw 36 base reads for MDA-MB-341 and 55,770,254 for SKN-1 cells were generated (Table 5). Only reads, which mapped unambiguously to the reference genome were considered, resulting in 7,575,990 and 12,130,697 for tumor and normal cell line samples, respectively. Overall, bisulfite conversion rates in these samples were roughly 99%. Reads were partitioned into those that mapped within the targeted region and those that did not. It was previously noted that sequences adjacent to target regions were also enriched using in situ capture. Although this does result from specific hybridization of fragments, which overlap terminal probes, such adjacent regions were not counted for calculating coverage or enrichment in our stringent analysis.

TABLE 4
Enrichment and coverage for targeted
regions for SKN-1 and MB-231

| Sample | MB-231 | SKN-1 |
|---|---|---|
| Treatment | bisulfite | bisulfite |
| Read Length | 36 | 36 |
| Reads | 20002407 | 55770254 |
| Reads In Genome | 7575990 | 12130697 |
| Reads In Capture Regions | 928726 | 799240 |
| Percent of Mapped Reads In Capture | 12.26 | 6.59 |
| Regions | | |
| Reads In Capture Regions: positive | 447270 | 388571 |
| strand | | |
| Reads In Capture Regions: negative | 381456 | 410669 |
| strand | | |
| Enrichment | 1459 | 784 |
| Median Read Depth: positive strand | 43 | 41 |
| Median Read Depth: negative strand | 45 | 41 |
| Coverage Positive Strand, Depth >= 1 | 0.9130 | 0.9129 |
| Coverage Positive Strand, Depth >= 9 | 0.8311 | 0.8188 |
| Coverage Negative Strand, Depth >= 1 | 0.9230 | 0.9232 |
| Coverage Negative Strand, Depth >= 9 | 0.8524 | 0.8366 |
| Coverage Either Strand, Depth >= 1 | 0.9356 | 0.9423 |
| Coverage Either Strand, Depth >= 9 | 0.9284 | 0.9335 |
| Coverage Both Strands, Depth >= 1 | 0.9005 | 0.8939 |
| Coverage Both Strands, Depth >= 9 | 0..7551 | 0.7219 |
| Bisulfite Unconverted Rate: positive | 0.0098 | 0.0088 |
| strand | | |
| Bisulfite Unconverted Rate: negative | 0.0099 | 0.0088 |
| strand | | |

Overall, 6.59 to 12.26% of mappable reads fell within the targeted CpG islands, corresponding to an enrichment of 784- to 1459-fold for selected regions from total genomic DNA (Table 4). Previous studies reported approximately 250-fold enrichment of unconverted DNA, but these also targeted larger genomic areas [25-27]. The optimal conditions using custom arrays to select similar genomic intervals from unconverted DNA routinely give three-fold greater enrichment than is seen with capture of bisulfite treated DNA [48]. Thus, conversion causes some loss of capture efficiency overall, which could be impacted, in these studies, by several factors. First, bisulfite conversion causes a loss of information content, and this simplification of the genome, coupled with having to design hybridization probes that infer potential methylation states, could impose intrinsic limits on the specificity and efficiency of hybridization. Second, inclusion of appropriate C₀t−1 DNA increases capture specificity by blocking non-specific hybridization of repeated sequences. While C₀t−1 DNA was used for these studies, it was unconverted. Therefore, the blocking agent would not have perfectly matched the repeat sequences present within our sample. Third, optimal capture requires the masking of probes that match repeat sequences within the genome. For capture of unconverted DNA, repeat-rich probes are identified based upon the average frequency with which 15-nucleotide segments of that probe match to the genome, with the cut-off for exclusion of a probe having been determined empirically as an average mapping frequency of 100. Because of the change in information content the same rule cannot be applied to the design of probes for bisulfite capture. Thus, for the studies presented here, probe sets were not repeat masked, and this likely lowered capture specificity.

Despite a modest loss in the overall efficiency of capture, good coverage of the targeted islands were still obtained, even using a single Illumina sequencing lane. For MDA-MB-231, 93.6% of nucleotides were covered by at least one read and 92.8% were covered by at least 9 reads, the latter number being sufficient for a confident call of a methylated or unmethylated state (Table 4). For SKN-1, 94.2% were interrogated by at least one read and 93.4% had sufficient information for a confident call.

Both coverage and enrichment rates likely underestimate the performance of the capture method, since some sequences within the target areas cannot be assigned as unique mapping locations in the genome. For an estimation of the extent of such “dead zones” and their relationship to read length, as described above.

### IV. Assigning Cytosine Methylation States

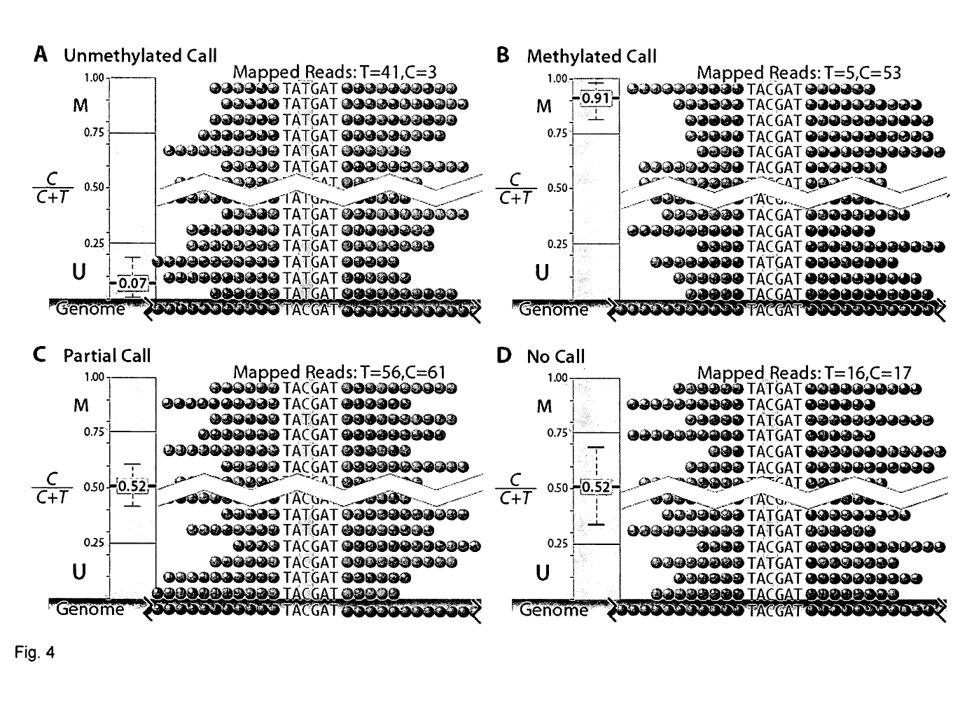

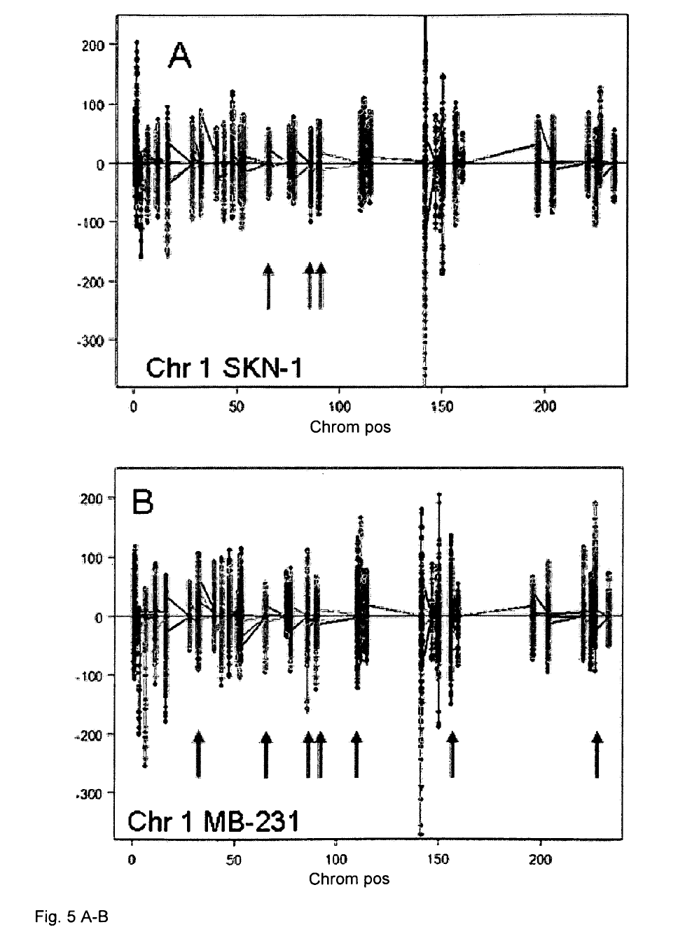

Variations in coverage depth, the relatively high rate of sequencing error, and the fact that individual cytosine residues can exist in mixture of methylated and unmethylated states within a given population of cells necessitated the development of rigorous statistical methods for calling methylation status (see Example 6). Overall, we began with two values, the fraction of unconverted cytosine residues at a given position and the number of times that the position was interrogated (FIG. 4). For these studies, symmetric was focused on, CpG methylation and therefore collapsed information obtained from both genomic strands. All reads having other than a C or T at a given CpG were excluded from analysis. Thus, the “methylated proportion” was defined as the number of reads with a C at a given CpG divided by the number of informative reads. Confidence intervals were calculated for the methylated proportion according to Wilson [37] and used these in conjunction with the methylated proportion to call methylation status. If the upper 0.95 confidence bound was less than 0.25, then that CpG was called unmethylated in the sample (FIG. 4A). If the lower 0.95 confidence bound was at least 0.75, then that CpG was called methylated in the sample (FIG. 4B). For the remaining CpGs, if the difference between the upper and lower 0.95 confidence bounds was less than or equal to 0.25, then the CpG was called “partially methylated” in that sample (FIG. 4C). Regardless of the observed frequency of Cs and Ts mapping over a CpG, if the difference between the upper and lower confidence bounds was greater than 0.25, then it was concluded that a confident call could not be made (FIG. 4D). This strategy resulted in confident calls for the vast majority of CpGs in the islands examined, and greater sequencing depth would certainly increase the number of confidently called CpGs.

In the 324 islands investigated in this analysis, there are 25043 CpG dinucleotides. For comparing methylation between cell lines, it was required that all CpGs considered reached the coverage needed for a confident call of a partially methylated state. Using the stringent criteria outlined above, 79.1% of the CpGs in the MDA-MB-231 sample, and 80.6% of those in CHP-SKN-1 could be given a confident call, either methylated, unmethylated or partially methylated.

As shown in Table 5, there are significantly more fully and partially methylated CpGs in the tumor sample, consistent with CpG island patterns described below in Table 6. Using these methylation state calls it is possible to devise a classification algorithm for the methylation status of individual CpG islands and to identify those that show different states in different samples (Table 6 and Example 6). Although many confident calls can be made, many islands show complex methylation patterns that may defy simple classification.

TABLE 5
Summary of methylation states determined for individual
CpGs in the SKN1 and MDAMB231 samples.

| | |
|---|---|
| SKN-1 | MDA-MB-231 |

| State | Reads | % | Reads | % |
|---|---|---|---|---|
| Unmethylated | 16118 | 64.4% | 11689 | 46.7% |
| Methylated | 2259 | 9.0% | 5099 | 20.4% |
| Other confident | 1880 | 7.5% | 3086 | 12.3% |
| No Call | 4786 | 19.1% | 5169 | 20.6% |
| CpG Total | 25043 | | 25043 | |

TABLE 6
Changes in island methylation state between the two cell lines.

| | MB-231 | | | | | | | |
|---|---|---|---|---|---|---|---|---|
| | Un- | | | | | | | |
| SKN-1 | methylated | | Methylated | | Partial | | No call | |
| Un- | 136 | (42%) | 14 | (4.3%) | 49 | (15.1%) | 3 | (0.9%) |
| methylated | | | | | | | | |
| Methylated | 0 | | 26 | (8%) | 6 | (1.9%) | 1 | (0.3) |
| Partial | 3 | (0.9%) | 16 | (4.9%) | 17 | (5.2%) | 1 | (0.3%) |
| No call | 4 | (1.2%) | 2 | (0.6%) | 2 | (0.6%) | 44 | (13.6%) |

CpG-Island methylation status classification changes between SKN1 and MDA-MB-231 samples. Islands are only included if a confident call could be made. (See Methods for definition of a confident island call)

### V. Patterns of CpG Island Methylation

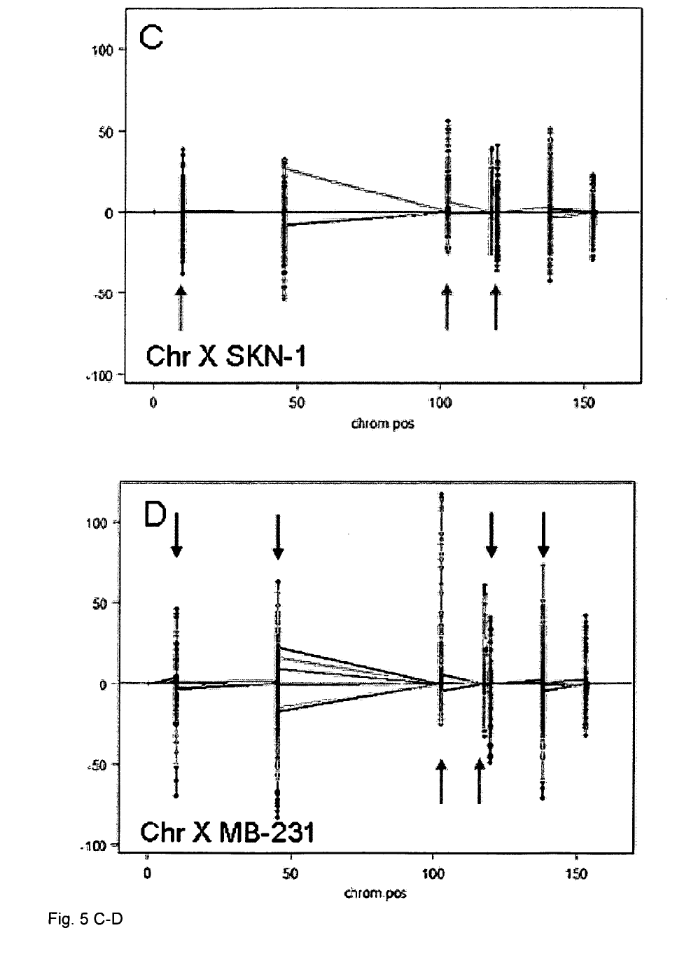

Generally, the expression state of a gene or the chromatin status of a region correlates with the overall density of CpG methylation [38,39]. Therefore methylation densities for the islands analyzed in these studies were plotted. A comparison of islands in tumor and normal cell lines across chromosomes 1 and X is shown in FIG. 5. In keeping with the expectation of hypermethylation for non-repetitive CpG islands in tumor cells, MDA-MB-231 cells had a greater number of methylated islands. Many islands had grossly similar methylation states in both cell lines, while a number of islands showed a switch between substantially unmethylated or substantially methylated states.

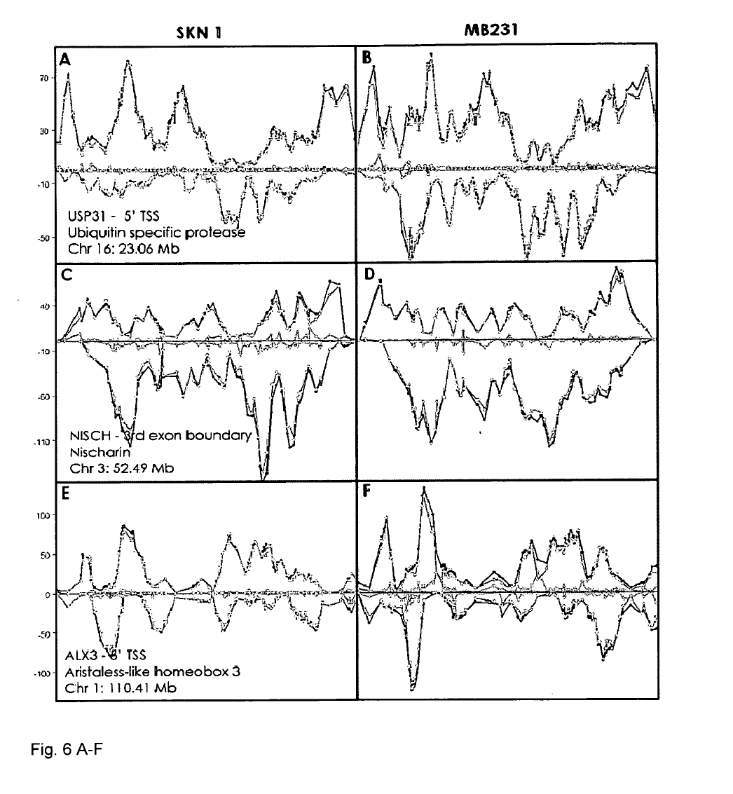

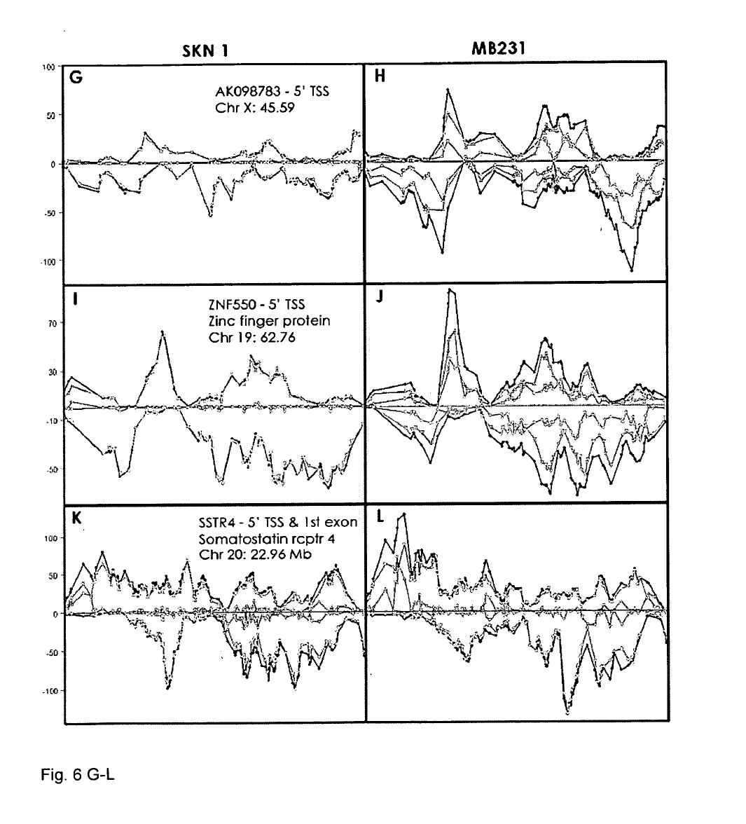

When individual islands were examined in more detail, they tended to fall into expected categories. Slightly more than half of the islands studied showed clearly defined methylation states in both samples. The most common (136/324) were islands that show very few calls of methylated C's in either the MDA-MB-231 or the SKN-1 sample (FIG. 6A,B) or were completely methylated (26/324) in both samples (FIG. 6C,D). In addition, a number of islands (14/324) that were virtually unmethylated in SKN-1 exhibited a complete change in state, becoming heavily methylated in the tumor sample, as exemplified by the island near ALX3 (FIG. 6E,F).

Notably, nearly half of the islands studied showed intermediate methylation densities in one or both samples. Intermediate methylation states would be expected for regions subject to dosage compensation in female cells. Indeed, observed were X-derived islands that were unmethylated in the male SKN-1 cells but which showed partial methylation in the female tumor cell line (FIG. 6G,H). There were also examples of partial methylation on autosomes (FIG. 6I,J). Finally, at least four contiguous UCSC-defined CpG islands had constituent domains with contrasting methylation status. One of the latter class is SSTR4 (FIG. 6K,L), where one segment of an island overlapping the transcriptional start site of the somatostatin receptor becomes methylated in the tumor cell line. Both types of intermediate methylation were subject to changes in state between samples. Overall, using the algorithm described, 79 cases were observed where methylation was significantly increased in MDA-MB-231 versus SKN-1 and 9 cases where methylation was higher in SKN-1. Such complexity underscores the need for an approach to characterizing CpG methylation that can address entire regions at single-nucleotide resolution.

### VI. Validation of the Approach

In conventional bisulfite sequencing single loci are amplified by PCR from converted DNA. Individual molecular products are sequenced as a pool, giving chromatograms that are base called and compared to the reference genome. Mixed methylation states at individual CpGs are apparent from overlapping C and T peaks in the sequence trace. Individual molecules can also be cloned and sequenced to provide more quantitative data. To validate the accuracy of our methodology versus the gold standard, capture bisulfite re-sequencing to conventional approaches were compared.

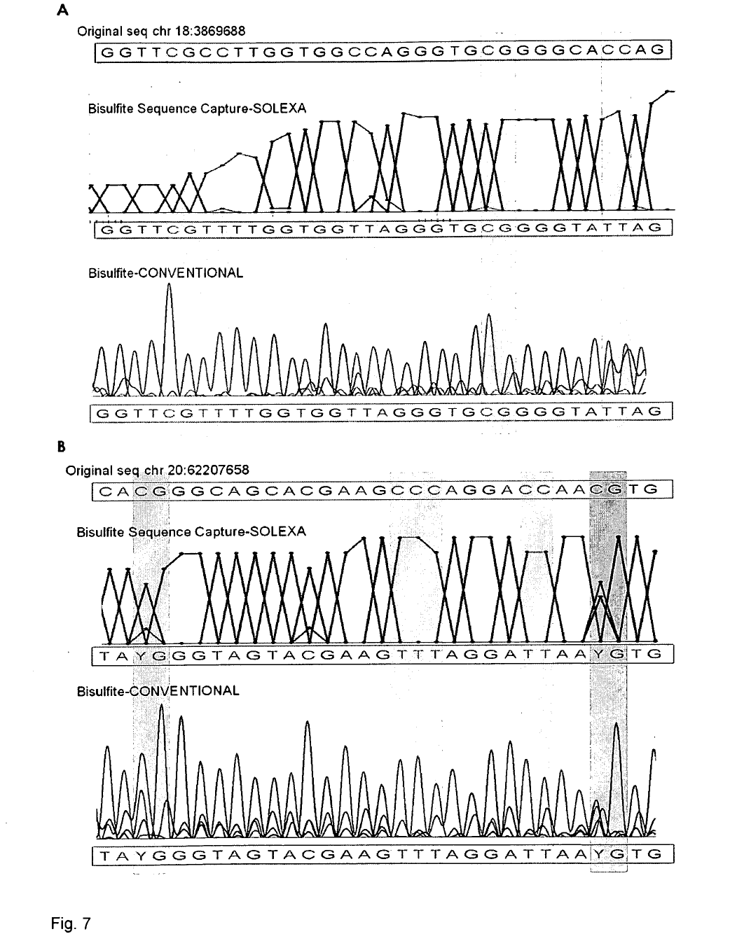

PCR amplicons were designed covering roughly 3 Kb of sequence sampled from CpG islands targeted for capture. These were amplified from bisulfite converted DNA from the SKN-1 cell line and sequenced by conventional capillary methods. A direct comparison revealed an overall >98% concordance between methylation calls based upon Illumina sequencing of captured DNA and conventional capillary sequencing of PCR amplified material. This included not only calls of fully methylated or unmethylated residues but also residues at which both methods detected intermediate methylation states. As examples, sequence traces were reconstructed based upon Illumina® sequencing of captured material and displayed these in comparison to actual traces from the same regions sequenced conventionally (FIG. 7). Areas of partial or complete CpG methylation of complete conversion of non-CpG residues are faithfully represented by both methods.

### VII. Chromatin Immunoprecipitation Sequencing (ChIPSeq)

Patterns of histone modification have been shown to closely correlate with DNA methylation [51}. Chromatin immunoprecipitation with massively parallel sequencing (ChIP-seq) for two histone modifications, H3K4me2 and H3K36me3, that reflect different genomic elements was performed. H3K4 is primarily associated with promoter regions, TSS and transcriptionally permissive chromatin, while histone H3K36 modifications are located primarily within the gene bodies of actively transcribed genes. Recently, a study describing H3K36me3 ChIP with microarray hybridization (ChIP-chip) in Caenorhabditis elegans noted a preferential marking of exons relative to introns [52]. Surprisingly, not only did our data corroborate this finding, but we also found a strong correlation between H3K36me3 and DNA methylation (Table 7).

TABLE 7
Comparison of ChIP-Seq reads overlapping exon and intron regions
and the corresponding DNA methylation status of the region.
MB231 H3K36 Total Reads 5266 Total Bases 56115

| | Regions | Reads | Bases | Reads/Kbp | Normalized |
|---|---|---|---|---|---|
| Exons | | | | | |
| Methylated | 55 | 3245 | 16004 | 202.8 | 2.16 |
| Unmethylated | 9 | 36 | 2462 | 14.6 | 0.16 |
| Partial | 12 | 72 | 4543 | 15.8 | 0.17 |
| No Call | 9 | 106 | 3696 | 28.7 | 0.31 |
| Total | 85 | 3459 | 26705 | 129.5 | 1.38 |
| Introns | | | | | |
| Methylated | 48 | 1390 | 9943 | 139.8 | 1.49 |
| Unmethylated | 20 | 100 | 6382 | 15.7 | 0.17 |
| Partial | 17 | 69 | 6261 | 11.0 | 0.12 |
| No Call | 28 | 248 | 6824 | 36.3 | 0.39 |
| Total | 113 | 1807 | 29410 | 61.4 | 0.65 |
| Both | | | | | |
| Methylated | 103 | 4635 | 25947 | 178.6 | 1.90 |
| Unmethylated | 29 | 136 | 8844 | 15.4 | 0.16 |
| Partial | 29 | 141 | 10804 | 13.1 | 0.14 |
| No Call | 37 | 354 | 10520 | 33.7 | 0.36 |
| Total | 198 | 5266 | 56115 | 93.8 | 1.00 |

MB231 H3K4 Total Reads 2253

| | Regions | Reads | Bases | Reads/Kbp | Normalized |
|---|---|---|---|---|---|
| Exons | | | | | |
| Methylated | 55 | 88 | 16004 | 5.5 | 0.14 |
| Unmethylated | 9 | 552 | 2462 | 224.2 | 5.58 |
| Partial | 12 | 69 | 4543 | 15.2 | 0.38 |
| No Call | 9 | 32 | 3696 | 8.7 | 0.22 |
| Total | 85 | 741 | 26705 | 27.7 | 0.69 |
| Introns | | | | | |
| Methylated | 48 | 61 | 9943 | 6.1 | 0.15 |
| Unmethylated | 20 | 1175 | 6382 | 184.1 | 4.59 |
| Partial | 17 | 245 | 6261 | 39.1 | 0.97 |
| No Call | 28 | 31 | 6824 | 4.5 | 0.11 |
| Total | 113 | 1512 | 29410 | 51.4 | 1.28 |
| Both | | | | | |
| Methylated | 103 | 149 | 25947 | 5.7 | 0.14 |
| Unmethylated | 29 | 1727 | 8844 | 195.3 | 4.86 |
| Partial | 29 | 314 | 10804 | 29.1 | 0.72 |
| No Call | 37 | 63 | 10520 | 6.0 | 0.15 |
| Total | 198 | 2253 | 56115 | 40.1 | 1.00 |

Column Headings
Regions refers to the number of regions having that methylation state for introns and exons.
Reads is the number of ChIP-seq reads mapping into regions of that type.
Total bases is the total number of bases in regions of that type.
The Reads/Kbp is the number of reads divided by the total bases multiplied by 1000.
Normalized refers to the proportion of reads in the ChIP-seq experiment, divided by the proportion of bases in the region type.

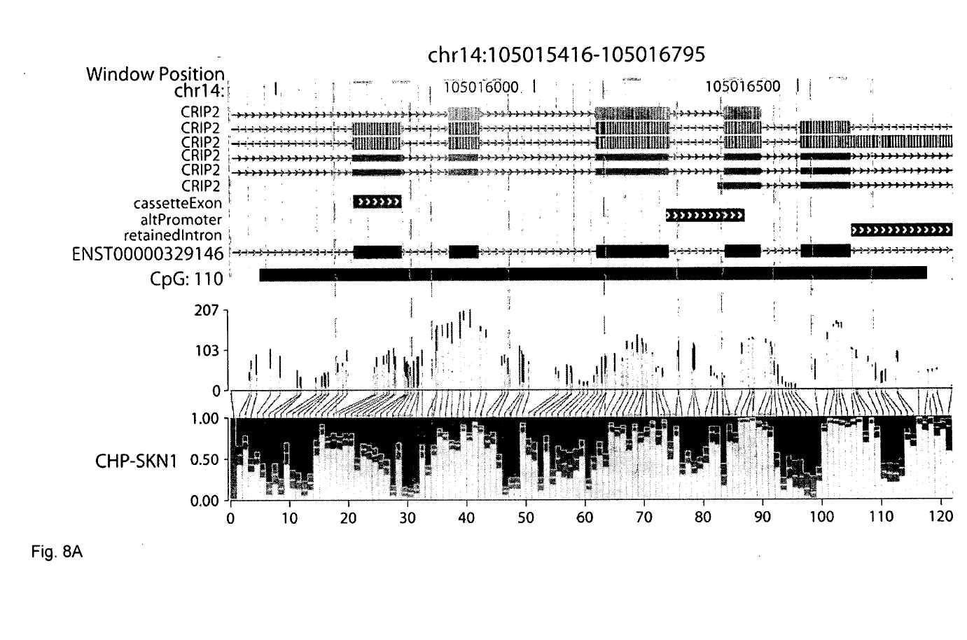

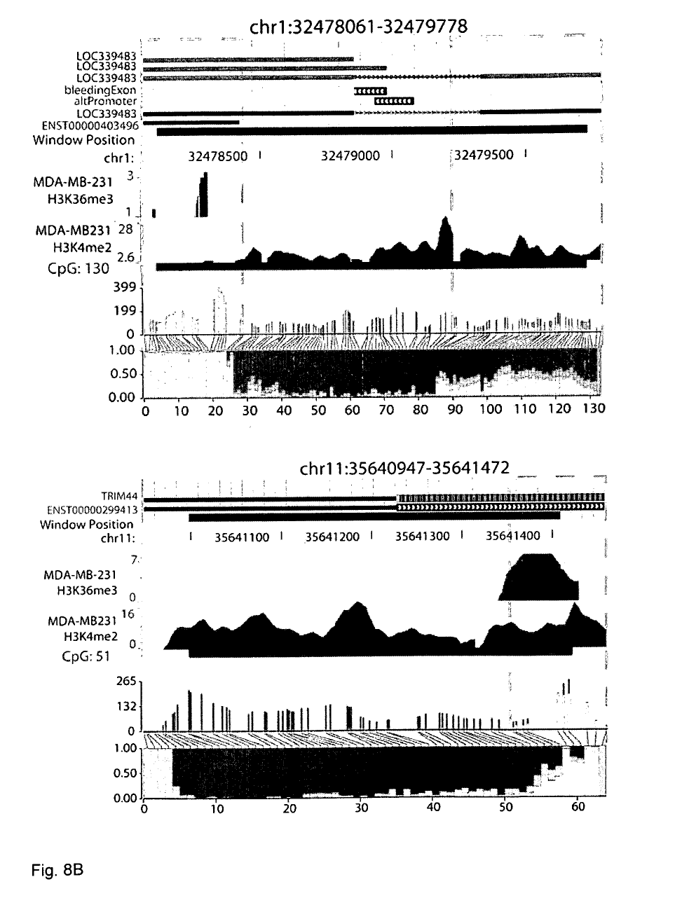

This is further supported by the observation that exons are enriched with DNA methylation. Conversely, we found that, as expected, H3K4me2 is correlated with lack of DNA methylation. Finally, we noted that, in many cases, the distribution of the two histone marks closely reflects the subregional patterns of DNA methylation within CpG islands (FIG. 8B).

Examination of the relationship between dinucleotide frequencies and overall methylation in CGIs was consistent with earlier reports, a strong negative correlation (−0.39 in CHP-SKN-1 and −0.32 in MDA-MB-231) between CpG density and total CGI methylation was observed [53]. However, a strong positive correlation was also observed (0.69 in CHP-SKN-1 and 0.54 in MDA-MB-231) between CA/TG frequency and total methylation of the CGIs. Furthermore, sharp cutoffs for frequencies of these dinucleotides can accurately distinguish hypomethylated islands from those showing partial or full methylation, with both strong sensitivity and specificity (see Tables 8 and 9).

TABLE 8
Correlation of CGI dinucleotide frequency
with methylation frequency (SKN1)

| | A | C | G | T | |
|---|---|---|---|---|---|
| A | −0.205 | 0.402 | 0.058 | 0.174 | 0.140 |
| C | 0.685 | −0.200 | 0.394 | 0.058 | −0.140 |
| G | −0.150 | −0.095 | −0.200 | 0.402 | −0.140 |
| T | −0.088 | −0.150 | 0.685 | −0.205 | 0.140 |

Prediction of methylation call (Unmethylated vs. Methylated and Partially
Methylated) based on dinucleotide frequency above a cutoff

| | Enriched in | | | | Average |
|---|---|---|---|---|---|
| Dinucleotide | unmethylated | Cutoff | Sensitivity | Specificity | Error |
| CA/TG | No | 0.0567 | 0.8904 | 0.7667 | 0.1715 |
| CG | Yes | 0.0955 | 0.7808 | 0.6190 | 0.3001 |

Calls: 1 = Meth, 0 = Unmeth, 2 = Partial (there are no CGIs included in these tables that did not receive a confident call)
Dinucleotide and nucleotide frequencies are symmetric because both strands are considered

TABLE 9
Correlation of CGI dinucleotide frequency
with methylation frequency (MDA-MB-231)

| | A | C | G | T | |
|---|---|---|---|---|---|
| A | −0.1528 | 0.2255 | 0.1901 | 0.0254 | 0.0716 |
| C | 0.5342 | −0.1489 | −0.3106 | 0.1901 | −0.0716 |
| G | −0.1213 | 0.0128 | −0.1489 | 0.2255 | −0.0716 |
| T | −0.1421 | −0.1213 | 0.5342 | −0.1528 | 0.0716 |

Prediction of methylation call (Unmethylated vs. Methylated and Partially
Methylated) based on dinucleotide frequency above a cutoff

| | Enriched in | | | | |
|---|---|---|---|---|---|
| Dinucleotide | unmethylated | Cutoff | Sensitivity | Specificity | Average Error |
| CA/TG | No | 0.0556 | 0.6875 | 0.7724 | 0.2700 |
| CG | Yes | 0.0974 | 0.6875 | 0.6552 | 0.3287 |

Calls: 1 = Meth, 0 = Unmeth, 2 = Partial (there are no CGIs included in these tables that did not receive a confident call)
Dinucleotide and nucleotide frequencies are symmetric because both strands are considered
Average error is 1 − (sensitivity + specificity)/2

This suggests existing definitions may not accurately capture the relationship between CpG density and protection from CpG depletion over evolutionary time scales. It is likely that more sophisticated definitions, which may account for characteristics beyond base composition, will be required to define the underlying evolutionary phenomena that produce CGIs.

### Example 7

SKN-1 cells were grown in 15 cm plates with DMEM medium containing 20% FBS supplemented with L-glutamine, nonessential amino acids and penicillin/streptomycin. MDA-MB-231 cells were grown in DMEM containing 15% FBS, L-glutamine, nonessential amino acids, and penicillin/streptomycin. Chromatin immunoprecipitation was performed with rabbit anti-trimethyl histone H3K36 (Abeam®, ab32356) and rabbit anti-dimethyl histone H3K4 (Abeam®, ab9050) according to previously described methods [54]. Following elution, IP samples were treated with RNaseA at 65° C. overnight followed by proteinase K at 42° C. for h. DNA was isolated by phenol:chloroform extraction and ethanol precipitation.

ChIP DNA for Illumine® sequencing was prepared based on an adapted protocol described by Robertson et al. (2007) [55]. Prior to starting the library construction, each sample was brought up to 75 μL using nuclease-free water. The DNA ends were then treated with a mixture of T4 DNA Polymerase, E. coli DNA polymerase I Klenow fragment, and T4 polynucleotide kinase to repair, blunt and phosphorylate ends according to the manufacturer's instructions (Illumina®). After a 30-min incubation at 20° C., 150 μL of 0.5 M NaCl was added to the 100 μL end-repair reactions. The mixtures were subjected to a phenol-chloroform-isoamyl alcohol (pH 8; 250 μL; Sigma®) extraction in 1.5 mL microcentrifuge tubes (Eppendorf®) and subsequently precipitated with 625 μL 100% ethanol for 20 min at −20° C. The DNA was recovered by centrifuging at 21,000 g for 15 min at 4° C. in a desktop refrigerated centrifuge and washed with 1 mL 70% ethanol. The pellets were resuspended in 32 μL prewarmed EB buffer (Qiagen®; 50° C.) and adenylated using Klenow exo-fragment following the manufacturer's instructions (Illumina). After a 30-min incubation at 37° C., the reaction volumes were brought up to 100 μL using EB buffer. The reaction mixtures were phenol-chloroform-isoamyl alcohol extracted and precipitated as above and resuspended in 10 μL prewarmed EB buffer. Illumina single end adaptors were then ligated to the adenylated fragments using the Roche Rapid Ligation Kit according to the manufacturer's recommendations. For the inputs and immunoprecipitated samples, the adaptor oligonucleotide mix was diluted 1/10 and 1/100, respectively. The DNA was recovered using the QIAquick PCR Purification Kit (Qiagen®) according to the manufacturer's instructions and eluted in 30 μL prewarmed EB buffer. The adaptor-ligated DNA was enriched by PCR using Phusion polymerase (Finnzymes®) and PCR primers 1.1 and 2.1 (Illumine®) following the manufacturer's instructions. One PCR reaction was prepared for the input libraries and six to seven parallel reactions for the immunoprecipitated libraries. The enriched input libraries were purified using a QIAquick MinElute PCR Purification Kit (Qiagen®) according to the manufacturer's instructions and eluted in 15 μL prewarmed EB buffer. The parallel reactions of the enriched immunoprecipitated DNA were combined, treated with 20 μL 5 M NaCl, and phenol-chloroform-isoamyl alcohol extracted and precipitated, as described above. The pellets were resuspended in 60 μL prewarmed EB buffer and gel-extracted using the MinElute Gel Extraction Kit (Qiagen®) following the manufacturer's instructions. A 200-350-bp region was size-selected and the DNA was eluted in 15 μL prewarmed EB buffer.

### VIII. Better Strand Selection

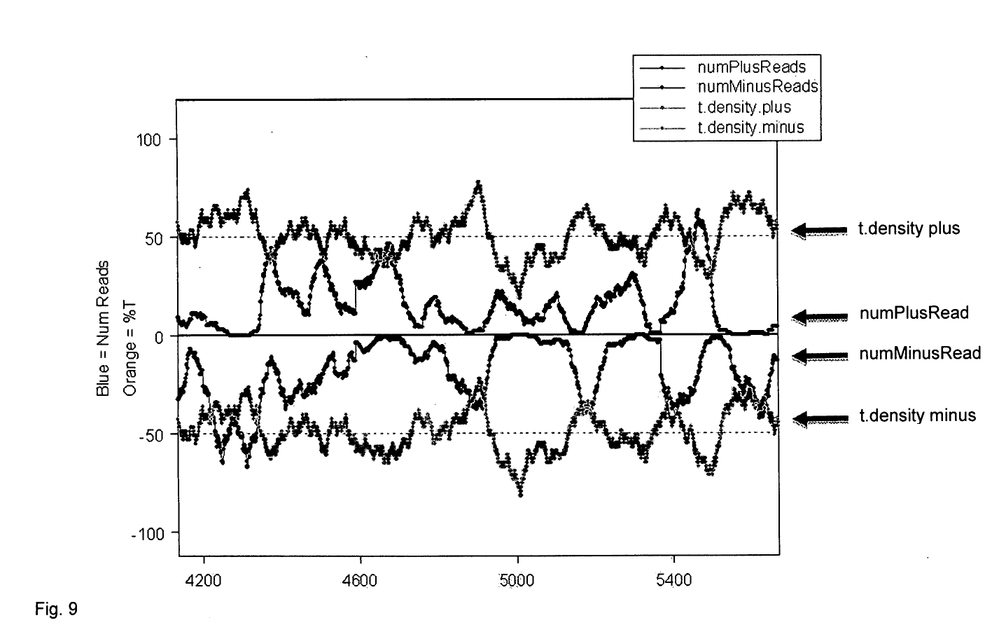

Although capture probes can be created complementary to the bisulfite converted sequence of either the plus or minus strand of any DNA segment, it is generally true that the number of mappable sequence reads will not be equivalent between the two strands. It was observed that where one strand yields many reads, the opposite strand is likely to have very few. This asymmetry in read depth was determined to correlated with the density of T residues in the bisulfite converted DNA sequence of each strand. The Y axis in FIG. 9 shows the read depth for the plus and minus strands (blue lines) above and below the X axis along a particular sequence of 1500 base pairs. The Y axis also reads in the same scale the percentage of T's in the fully converted sequence for a sliding window 50 bp in length. It was found that the T density is inversely correlated to the read depth for both strands.

In mammalian genomes where DNA methylation is almost always symmetric on the two strands, sequencing one of the strands would suffice. However, genomes having asymmetrical methylation at some sites, i.e. maize, information would be lost if only one strand were sequenced. Due to the complementary nature of DNA, the percent of Cs plus Ts on one strand is the same as 1−the percent of Cs+Ts on the other strand for any given stretch of sequence. Accordingly, one strand must always have less than or equal to 50% of nucleotides being Cs and Ts. If for a given potential probe sequence on the plus strand the Cs and Ts are less than or equal to 50% of the bases then we select a probe pair from the plus strand, otherwise from the minus strand.

It is therefore possible to use this information to create a more efficient capture array by arranging the probes according to which strand has the lowest C and T density in any given region. By screening probes according to C and T density, it is possible to optimize the capture array by using probes which are targeted to genome regions having a certain maximum C and T density. For example, excluding probes with higher than 50% C and T density it will be possible to build an array capable of capturing twice the genomic sequence of a non-optimized array.

### IX. CpG Islands

In mammalian genomes the CpG dinucleotide occurs about 20% as frequently as expected, based on the overall C+G content. There are regions of the genome where CpG dinucleotides are less depleted than average. These regions are called CpG islands. There are various criteria to computationally annotate CpG islands. Commonly used criteria are by Gardiner-Garden and Frommer, a modified version of Gardiner-Garden and Frommer used for the UCSC Genome Browser Database, and Takai and Jones. Methylation pattern at the center of most islands was observed to be a good representation of the methylation pattern across the island as a whole.

### Example 9

DNA methylation was measured in all the CpG islands annotated in the UCSC Genome Browser Database. Probes were placed across a −100 base region near the center of every CpG island. This region is selected as follows. Each CpG island annotation gives start and end coordinates in the genome. The center of the island is computed as center=(end−start)/2. A test region is defined as going from center−50 to center+49. If this 100 base window has no repeat masked bases, then this window is selected. If there are repeat masked bases, then the center is shifted as new center=center−10. If the window centered here is clear of repeat masked bases, then this is the selected window. Otherwise, the new center is original center+10 bases. This is repeated until a 100 base window free of repeat masked bases is found or the window has moved beyond the boundary of the CpG island, i.e. the sequence is center, center−10, center+10, center−20, center+20, center−30, center+30, etc. Once a window free of repeat masked bases is found, probes are selected for this region. There are only 17 CpG island in the human genome without a 100 base window free of repeated masked bases using the method described above.

Currently, 17 probes pairs are selected for each CpG island in the human genome. Placing a probe pair every 6 bases means the distance from the start coordinate of the first probe pair to the last probe pair in the window is 96 bases. The probes are 60 bases long. The first probe pair selected starts at the window center minus 82 bases. Then probe pairs are selected every 6 bases from the better strand. If more than 50% of the probe sequence is repeat masked that probe pair is skipped.

However, in genomes with fewer CpG islands as compared to the human genome, a 100 based pair window may be selected without repeat masked bases, i.e. for the mouse genome, 31 probes are selected for each island instead.

### Discussion

Changes in the methylation status of many genes have been correlated with cell fate decisions and with the development of human disease. Here disclosed is a straightforward, reproducible, and well-validated set of tools that allow DNA methylation patterns to be tracked in large segments of the human genome at single-base resolution.

The use of custom microarrays as substrates for capture of high interest regions from complex genomes has recently been described [25-27]. This permits identification of sequence variants within coding regions or other similarly high value genomic intervals. Here, disclosed is the adaptation of this focal resequencing method for the determination of DNA methylation patterns at singlebase resolution. This approach relies on the treatment of genomic DNA with sodium bisulfite to convert all unmethylated cytosines to uridines prior to capture. Importantly, treatment with sodium bisulfite prior to capture allows very small amounts of starting material, for example from highly purified, rare cell populations, to be used for epigenome mapping.

Building upon established array-capture methods [25-27], we designed strategies that allow substantial purification of bisulfite treated DNA from selected, non-repeat portions of mammalian genomes. This procedure takes advantage of the ability of 60 nt oligonucleotide probes to tolerate several mismatches without a dramatic effect on hybridization efficiency [33,34]. Probes corresponding to the extreme states were designed, with all CpGs in the target region either fully methylated or fully unmethylated. This created a probe set that would match to selected regions sufficiently for capture, even if CpG dinucleotides in target fragments were methylated randomly. Evidence for capture of molecules with mixed methylation states comes from the recovery of fragments represented by reads that contain both methylated and unmethylated residues. Therefore, this analysis does not bias the determination of methylation patterns based toward local uniformity in CpG methylation.

While many CpG islands did satisfy preconceptions, showing near complete methylation or lack thereof, many also had more complex modification patterns. These had segments or domains of high methylation and neighboring domains, which were unmethylated. The overall biological significance and correlation with expression state of such patterns have yet to be determined.

The studies used 36-base Illumina® GA2 sequence reads to analyze captured material. Because of the unusual density of CpG residues within the targeted regions, even these short reads often contained multiple CpG sites. This offers the potential for stringing together information about the modification state of individual CpGs into patterns that might represent the states of individual chromosomes. Reconstruction of such “eplitypes” will be greatly aided as read lengths on next-generation platforms increase and will be important for interpreting the relevance of epigenetic states in samples with mixed cell types.

The completion of the human genome sequence was a landmark in biology. The determination of the epigenome sequence is a problem of much greater scale, as for any individual, there may be as many different epigenomic states as there were cell types through the entire developmental history of the organism. An understanding of epigenetic impacts on cell fate specification and restriction requires an ability to monitor substantial fractions of the epigenome in potentially very rare cell types. This will be greatly aided by the availability of capture technologies to recover selected regions from bisulfite treated samples that can then be characterized by next-generation sequencing.

### REFERENCES

1. Waddington, C. H. The epigenotype. Endeavour 1, 18-20 (1942).
2. Jaenisch, R. & Bird, A. Epigenetic regulation of gene expression: how the genome integrates intrinsic and environmental signals. Nat Genet. 33 Suppl, 245-54 (2003).
3. Ptashne, M. On the use of the word ‘epigenetic’. Curr Biol 17, R23 3-6 (2007).
4. Katan-Khaykovich, Y. & Struhl, K. Dynamics of global histone acetylation and deacetylation in vivo: rapid restoration of normal histone acetylation status upon removal of activators and repressors. Genes Dev 16, 743-52 (2002).
5. Klose, R. J. & Bird, A. P. Genomic DNA methylation: the mark and its mediators. Trends Biochem Sci 31, 89-97 (2006).
6. Zhang, X., Shiu, S., Cal, A. & Borevitz, J. D. Global analysis of genetic, epigenetic and transcriptional polymorphisms in Arabidopsis thaliana using whole genome tiling arrays. PLoS Genet. 4, e1000032 (2008).
7. Cross, S. H. & Bird, A. P. CpG islands and genes. Curr Opin Genet Dev 5, 309-14 (1995).
8. Bourc'his, D. & Bestor, T. H. Meiotic catastrophe and retrotransposon reactivation in male germ cells lacking Dnmt3L. Nature 431, 96-9 (2004).
9. Walsh, C. P., Chaillet, J. R. & Bestor, T. H. Transcription of lAP endogenous retroviruses is constrained by cytosine methylation. Nat Genet. 20, 116-7 (1998).
10. Ideraabdullah, F. Y., Vigneau, S. & Bartolomei, M. S. Genomic imprinting mechanisms in mammals. Mutat Res (2008).
11. Okano, M., Bell, D. W., Haber, D. A. & Li, E. DNA methyltransferases Dnmt3a and Dnmt3b are essential for de novo methylation and mammalian development. Cell 99, 247-57 (1999).
12. Lei, H. et al. De novo DNA cytosine methyltransferase activities in mouse embryonic stem cells. Development 122, 3195-205 (1996).
13. Robertson, K. D. DNA methylation and human disease. Nat Rev Genet. 6, 597-610 (2005).
14. Cooper, D. N. & Krawczak, M. Cytosine methylation and the fate of CpG dinucleotides in vertebrate genomes. Hum Genet. 83, 181-8 (1989).
15. Takai, D. & Jones, P. A. Comprehensive analysis of CpG islands in human chromosomes 21 and 22. Proc Natl Acad Sci USA 99, 3740-5 (2002).
16. Hermann, A., Goyal, R. & Jeltsch, A. The Dnmt1 DNA (cytosine-C5)-methyltransferase methylates DNA processively with high preference for hemimethylated target sites. J Biol Chem 279, 48350-9 (2004).
17. Li, E., Beard, C., Forster, A. C., Bestor, T. H. & Jaenisch, R. DNA methylation, genomic imprinting, and mammalian development. Cold Spring Harb Symp Quan t Biol 58, 297-305 (1993).
18. Robertson, K. D. & Wolffe, A. P. DNA methylation in health and disease. Nat Rev Genet. 1, 11-9 (2000).
19. Kriaucionis, S. & Bird, A. DNA methylation and Rett syndrome. Hum Mol Genet. 12 Spec No 2, R221-7 (2003).
20. Ting, A. H., McGarvey, K. M. & Baylin, S. B. The cancer epigenome—components and functional correlates. Genes Dev 20, 3215-31 (2006).
21. Suzuki, M. M. & Bird, A. DNA methylation landscapes: provocative insights from epigenomics. Nat Rev Genet. 9, 465-76 (2008).
22. Cokus, S. J. et al. Shotgun bisulphite sequencing of the Arabidopsis genome reveals DNA methylation patterning. Nature 452, 215-9 (2008).
23. Meissner, A. et al. Genome-scale DNA methylation maps of pluripotent and differentiated cells. Nature 454, 766-70 (2008).
24. Lister, R. et al. Highly integrated single-base resolution maps of the epigenome in Arabidopsis. Cell 133, 523-36 (2008).
25. Hodges, E. et al. Genome-wide in situ ex on capture for selective resequencing. Nat Genet. 39, 1522-7 (2007).
26. Albert, T. J. et al. Direct selection of human genomic loci by microarray hybridization. Nat Methods 4, 903-5 (2007).
27. Okou, D. T. et al. Microarray-based genomic selection for high-throughput resequencing. Nat Methods 4, 907-9 (2007).
28. Gardiner-Garden, M. & Frommer, M. CpG is lands in vertebrate genomes. J Mol Biol 196, 261-82 (1987).
29. Frommer, M. et al. A genomic sequencing protocol that yields a positive display of 5-methylcytosine residues in individual DNA strands. Proc Natl Acad Sci USA 89, 1827-31 (1992).
30. Rarnsahoye, B. H. et al. Non-CpG methylation is prevalent in embryonic stern cells and may be mediated by DNA methyltransferase 3a. Proc Natl Acad Sci USA 97, 5237-42 (2000).
31. White, G. P., Watt, P. M., Holt, B. J. & Holt, P. G. Differential patterns of methylation of the IFN-gamma promoter at CpG and non-CpG sites underlie differences in IFN-gamma gene expression between human neonatal and adult CD45RO-T cells. J Immunol 168, 2820-7 (2002).
32. Grandjean, V., Yaman, R., Cuzin, F. & Rassoulzadegan, M. Inheritance of an epigenetic mark: the CpG DNA methyltransferase 1 is required for de novo establishment of a complex pattern of non-CpG methylation. PLoS ONE 2, e1136 (2007).
33. Jabado, O. J. et al. Comprehensive viral oligonucleotide probe design using conserved protein regions. Nucleic Acids Res 36, e3 (2008).
34. Hughes, T. R. et al. Expression profiling using microarrays fabricated by an ink-jet oligonucleotide synthesizer. Nat Biotechnol 19, 342-7 (2001).
35. Gusfield, D. Algorithms on Strings, Trees, and Sequences: Computer Science and Computational Biology. Cambridge University Press, 1997.
36. Pevzner, P. A. et al. Multiple filtration and approximate pattern matching. Algorithmica, 13(1/2): 135-154, 1995.
37. Wilson, E. B. Probable inference, the law of succession, and statistical inference. Journal of the American Statistical Association 22, 209-212 (1927).
38. Bird, A. DNA methylation patterns and epigenetic memory. Genes Dev 16, 6-21 (2002).
39. Bird, A. P. DNA methylation versus gene expression. J Embryol Exp Morphol 83 Suppl, 31-40 (1984).
40. Xiong Z, Laird P W. 1997. COBRA: A sensitive and quantitative DNA methylation assay. Nucleic Acids Res 25: 2532-2534.
41. Ehrich M, Nelson M R, Stanssens P, Zabeau M, Liloglou T, Xinarianos G, Cantor C R, Field J K, van den Boom D. 2005. Quantitative highthroughput analysis of DNA methylation patterns by base-specific cleavage and mass spectrometry. Proc Natl Acad Sci 102: 15785-15790.
42. Ehrich M, Turner J, Gibbs P, Lipton L, Giovanneti M, Cantor C, van den Boom D. 2008. Cytosine methylation profiling of cancer cell lines. Proc Natl Acad Sci 105: 4844-4849.
43. Eads C A, Danenberg K D, Kawakami K, Saltz L B, Blake C, Shibata D, Danenberg P V, Laird P W. 2000. MethyLight: A high-throughput assay to measure DNA methylation. Nucleic Acids Res 28: e32. doi: 10.1093/nar/28.8.e32.
44. Dupont J M, Tost J, Jammes H, Gut I G. 2004. De novo quantitative bisulfite sequencing using the pyrosequencing technology. Anal Biochem 333: 119-127.
45. Cokus S J, Feng S, Zhang X, Chen Z, Merriman B, Haudenschild C D, Pradhan S, Nelson S F, Pellegrini M, Jacobsen S E. 2008. Shotgun bisulphate sequencing of the Arabidopsis genome reveals DNA methylation patterning. Nature 452: 215-219.
46. Taylor K H, Kramer R S, Davis J W, Guo J, Duff D J, Xu D, Caldwell C W, Shi H.2007. Ultradeep bisulfite sequencing analysis of DNA methylation patterns in multiple gene promoters by 454 sequencing. Cancer Res 67: 8511-8518.
47. Meissner A, Mikkelsen T S, Gu H, Wernig M, Hanna J, Sivachenko A, Zhang X, Bernstein B E, Nusbaum C, Jaffe D B, et al. 2008. Genome-scale DNA methylation maps of pluripotent and differentiated cells. Nature 454:766-770.
48. Hodges E, et al. High definition profiling of mammalian DNA methylation by array capture and single molecule bisulfite sequencing. Genome Res. 2009 September; 19(9):1593-605. Epub 2009 Jul. 6.
49. Smith A, Xuan Z, Zhang M. 2008. Using quality scores and longer reads improves accuracy of Solexa read mapping. BMC Bioinformatics 9: 128. doi: 10.1186/1471-2105-9-128.
50. Pevzner P A, Waterman M S. 1995. Multiple filtration and approximate pattern matching. Algorithmica 13: 135-154.
51. Meissner A, Mikkelsen T S, Gu H, Wernig M, Hanna J, Sivachenko A, Zhang X, Bernstein B E, Nusbaum C, Jaffe D B, et al. 2008. Genome-scale DNA methylation maps of pluripotent and differentiated cells. Nature 454: 766-770.
52. Kolasinska-Zwierz P, Down T, Latorre I, Liu T, Liu X S, Ahringer J. 2009. Differential chromatin marking of introns and expressed exons by H3K36me3. Nat Genet. 41: 376-381.
53. Zhang Y, Rohde C, Tierling S, Jurkowski T P, Bock C, Santacruz D, Ragozin S, Reinhardt R, Groth M, Walter J, et al. 2009. DNA methylation analysis of chromosome 21 gene promoters at single base pair and single allele resolution. PLoS Genet. 5: e1000438. doi: 10.1371/journal. pgen.1000438.
54. Steger D J, Lefterova M I, Ying L, Stonestrom A J, Schupp M, Zhuo D, Vakoc A L, Kim J E, Chen J, Lazar M A, et al. 2008. DOT1L/KMT4 recruitment and H3K79 methylation are ubiquitously coupled with gene transcription in mammalian cells. Mol Cell Biol 28: 2825-2839.
55. Robertson G, Hirst M, Bainbridge M, Bilenky M, Zhao Y, Zeng T, Euskirchen G, Bernier B, Varhol R, Delaney A, et al. 2007. Genome-wide profiles of STAT1 DNA association using chromatin immunoprecipitation and massively parallel sequencing. Nat Methods 4: 651-657.

1. A process for determining the DNA methylation state of CpG dinucleotides within a plurality of regions of interest of genomic DNA, the method comprising:
a) providing fragments of the genomic DNA;
b) ligating adaptors to the 5′ and to the 3′ ends of the fragmented DNA of step a) to form primary ligated material, wherein cytosine residues of the adaptors have a protecting group which inhibits deamination resulting from bisulfite treatment;
c) subjecting the primary ligated material of step b) to bisulfite treatment to form bisulfite-converted material, such that unprotected cytosines of the primary ligated material are converted to uridines;
d) amplifying the bisulfite-converted material by PCR amplification using primer sequences present on the adaptors to generate an amplification product, such that uridines in the sequence of the bisulfite-converted material of step c) are thymidines in the sequence of the amplification product;
e) denaturing the amplification product to form single-stranded DNA fragments;
f) capturing single-stranded DNA fragments comprising sequences spanning regions of within the plurality of regions of the genome by hybridizing the single-stranded DNA fragments of step e) to a capture array which comprises a plurality of probe sets, wherein each probe set consists of one, two, three or four two-probe subsets, such that each two-probe subset consist of either
i) a first probe having a sequence which corresponds to the sequence of a segment of a single strand within a region comprising a CpG dinucleotide, with the exception that every cytosine (C) residue of the segment of the single strand of DNA is a thymine (T) residue in the first probe; and
ii) a second probe having a sequence which corresponds to the sequence of the same segment of the single strand comprising a CpG dinucleotide, with the exception that every cytosine (C) residue of the segment, other than the cytosine (C) residue of the CpG dinucleotide, is a thymine (T) residue in the second probe; or
iii) a probe fully complementary to the first probe; and
iv) a probe fully complementary to the second probe;
g) eluting the captured single-stranded DNA fragments and sequencing the eluted fragments to obtain sequence reads; and
h) mapping the sequence reads to a reference genome,
thereby determining the methylation state of CpG dinucleotides within the regions of interest.

2-14. (canceled)

15. A DNA array comprising a plurality of probe sets, each probe set consisting of one, two, three or four two-probe subsets, each two-probe subset consisting of
i) a first probe having a sequence which corresponds to the sequence of a segment of a single strand within a region comprising a CpG dinucleotide, with the exception that every cytosine (C) residue of the segment of the single strand of DNA is a thymine (T) residue in the first probe; and
ii) a second probe having a sequence which corresponds to the sequence of the same segment of the single strand comprising a CpG dinucleotide, with the exception that every cytosine (C) residue of the segment, other than the cytosine (C) residue of the CpG dinucleotide, is a thymine (T) residue in the second probe; or
iii) a probe fully complementary to the first probe; and
iv) a probe fully complementary to the second probe.

16. The DNA array of claim 15, wherein if two, three or four two-probe subsets are present in each probe set of the DNA microarray, each two-probe subset within each probe set is different.

17. The DNA array of claim 15, wherein each probe set consists of two different two-probe subsets.

18. The DNA array of claim 15, wherein
a) one of the two different two-probe subsets consists of
i) a first probe having a sequence which corresponds to the sequence of a segment of a single strand within a region comprising a CpG dinucleotide, with the exception that every cytosine (C) residue of the segment of the single strand of DNA is a thymine (T) residue in the first probe; and
ii) a second probe whose sequence which corresponds to the sequence of the same segment of the single strand comprising a CpG dinucleotide, with the exception that every cytosine (C) residue of the segment, other than the cytosine (C) residue of the CpG dinucleotide, is a thymine (T) residue in the second probe, and
b) the other of the two different two-probe subsets consists of
i) a third probe having a sequence which corresponds to the sequence of the full complement of the segment of the single strand comprising the CpG dinucleotide, with the exception that every cytosine (C) residue of the known single stranded DNA segment is a thymine (T) residue in the first probe; and
ii) a fourth probe having a sequence which corresponds to the sequence of the full complement of the segment of the single strand comprising a CpG dinucleotide, with the exception that every cytosine (C) residue of the segment, other than the cytosine (C) residue of the CpG dinucleotide, is a thymine (T) residue in the second probe.

19. The DNA array of claim 15, wherein
a) one of the two different two-probe subsets consists of
i) a first probe having a sequence which corresponds to the sequence of a segment of a single strand within a region comprising a CpG dinucleotide, with the exception that every cytosine (C) residue of the segment of the single strand of DNA is a thymine (T) residue in the first probe; and
ii) a second probe whose sequence which corresponds to the sequence of the same segment of the single strand comprising a CpG dinucleotide, with the exception that every cytosine (C) residue of the segment, other than the cytosine (C) residue of the CpG dinucleotide, is a thymine (T) residue in the second probe, and
b) the other of the two different two-probe subsets consists of
i) a third probe which is fully complementary to a probe having a sequence which corresponds to the sequence of the full complement of the segment of the single strand comprising the CpG dinucleotide, with the exception that every cytosine (C) residue of the known single stranded DNA segment is a thymine (T) residue in the first probe; and
ii) a fourth probe which is fully complementary to a probe having a sequence which corresponds to the sequence of the full complement of the segment of the single strand comprising the CpG dinucleotide, with the exception that every cytosine (C) residue of the segment, other than the cytosine (C) residue of the CpG dinucleotide, is a thymine (T) residue in the second probe.

20. The DNA array of claim 15, wherein
a) one of the two different two-probe subsets consists of
i) a first probe which is fully complementary to a probe having a sequence corresponding to the sequence of a segment of a single strand within a region comprising a CpG dinucleotide, with the exception that every cytosine (C) residue of the segment of the single strand of DNA is a thymine (T) residue in the first probe; and
ii) a second probe which is fully complementary to a probe having a sequence corresponding to the sequence of the same segment of the single strand comprising a CpG dinucleotide, with the exception that every cytosine (C) residue of the segment, other than the cytosine (C) residue of the CpG dinucleotide, is a thymine (T) residue in the second probe, and
b) the other of the two different two-probe subsets consists of
i) a third probe having a sequence which corresponds to the sequence of the full complement of the segment of the single strand comprising a CpG dinucleotide, with the exception that every cytosine (C) residue of the known single stranded DNA segment is a thymine (T) residue in the first probe; and
ii) a fourth probe having a sequence which corresponds to the sequence of the full complement of the segment of the single strand comprising a CpG dinucleotide, with the exception that every cytosine (C) residue of the segment, other than the cytosine (C) residue of the CpG dinucleotide, is a thymine (T) residue in the second probe.

21. The DNA array of claim 15, wherein
a) one of the two different two-probe subsets consists of
i) a first probe which is fully complementary to a probe having a sequence corresponding to the sequence of a segment of a single strand within a region comprising a CpG dinucleotide, with the exception that every cytosine (C) residue of the segment of the single strand of DNA is a thymine (T) residue in the first probe; and
ii) a second probe which is fully complementary to a probe having a sequence corresponding to the sequence of the same segment of the single strand comprising a CpG dinucleotide, with the exception that every cytosine (C) residue of the segment, other than the cytosine (C) residue of the CpG dinucleotide, is a thymine (T) residue in the second probe, and
b) the other of the two different two-probe subsets consists of
i) a third probe which is fully complementary to a probe having a sequence corresponding to the sequence of the full complement of the segment of the single strand comprising a CpG dinucleotide, with the exception that every cytosine (C) residue of the known single stranded DNA segment is a thymine (T) residue in the first probe; and
ii) a fourth probe which is fully complementary to a probe having a sequence corresponding to the sequence of the full complement of the segment of the single strand comprising a CpG dinucleotide, with the exception that every cytosine (C) residue of the segment, other than the cytosine (C) residue of the CpG dinucleotide, is a thymine (T) residue in the second probe.

22. The DNA array of claim 15, wherein the probes are attached to a solid support.

23. The DNA array of claim 15, wherein the array consists of a single contiguous solid support.

24. The DNA array of claim 15, wherein the probes are designed to correspond to segments of a genome each of which has a combined total density of C residues plus T residues, excluding C residues of CpG dinucleotides, of less than 50%.

25. The DNA array of claim 15, wherein each probe corresponds to a segment of a CpG island within the genome.

26. The DNA array of claim 25, wherein the segment of the CpG island is 40-250 nucleotides.

27. The DNA array of claim 26, wherein the segment is centered within the CpG island.

28. The DNA array of claim 25, wherein the segment is free of repetitive sequences.

29. A methylation map of a segment of a genome obtained by detecting methylation of cytosine in CpG dinucleotides within a genome by the process of claim 1.

30. A process for obtaining information for determining the DNA methylation state of CpG dinucleotides within a plurality of regions of interest of genomic DNA comprising:
a) producing fragments of the genomic DNA;
b) ligating adaptors to the 5′ and to the 3′ ends of the fragmented DNA of step a) to form primary ligated material, wherein cytosine residues of the adaptors have a protecting group which inhibits deamination resulting from bisulfite treatment;
c) subjecting the primary ligated material of step b) to bisulfite treatment to form bisulfite-converted material, such that unprotected cytosines of the primary ligated material are converted to uridines;
d) amplifying the bisulfite-converted material by PCR amplification using primer sequences present on the adaptors to generate an amplification product, such that uridines in the sequence of the bisulfite-converted material of step c) are thymidines in the sequence of the amplification product;
e) denaturing the amplification product to form single-stranded DNA fragments;
f) capturing single stranded DNA fragments comprising sequences spanning regions of within the plurality of regions of the genome by hybridizing the single-stranded DNA fragments of step e) to a capture array which comprises a plurality of probe sets, wherein each probe set consists of one, two, three or four two-probe subsets, such that each two-probe subset consist of
i) a first probe having a sequence which corresponds to the sequence of a segment of a single strand within a region comprising a CpG dinucleotide, with the exception that every cytosine (C) residue of the segment of the single strand of DNA is a thymine (T) residue in the first probe; and
ii) a second probe having a sequence which corresponds to the sequence of the same segment of the single strand comprising a CpG dinucleotide, with the exception that every cytosine (C) residue of the segment, other than the cytosine (C) residue of the CpG dinucleotide, is a thymine (T) residue in the second probe; or
iii) a probe fully complementary to the first probe; and
iv) a probe fully complementary to the second probe; and
g) eluting the captured single-stranded DNA fragments and sequencing the eluted fragments to obtain sequence reads, thereby obtaining the information for determining the DNA methylation state.

31. A computer implemented process for determining the DNA methylation state of CpG dinucleotides within a plurality of regions of interest of genomic DNA, the method comprising
a) inputting the information obtained by the process of claim 30 into a mapping algorithm;
b) matching each sequence read to a reference genome using the mapping algorithm;
c) excluding from consideration portions of the reference genome that have no probability of matching the sequence read; and
d) assigning fractional mismatch penalties based upon the certainty of a base prediction, wherein the certainty of the base prediction takes into account fractional conversions of cytosines to thymine.

32. The process of claim 31 using mismatch counts from RMAPBS algorithms.

33. The process of claim 31 using base-call quality scores from RMAPBSQ algorithms.

34. The process of claim 31 which accounts for cytosine to thymine conversions at unmethylated cytosines.

35. The process of claim 31 which accounts for cytosines protected from conversion by methylation.

36-41. (canceled)


SEQUENCE LISTING (25 sequences)

SEQ ID NO: 1 - DNA, 58 bp, Artificial
  Blocking Oligonucleotide BO1
aatgatacggcgaccaccgagatctacactctttccctacacgacgctcttccgatct

SEQ ID NO: 2 - DNA, 61 bp, Artificial
  Blocking Oligonucleotide BO2
caagcagaagacggcatacgagatcggtctcggcattcctgctgaaccgctcttccgatct

SEQ ID NO: 3 - DNA, 58 bp, Artificial
  Blocking Oligonucleotide BO3
agatcggaagagcgtcgtgtagggaaagagtgtagatctcggtggtcgccgtatcatt

SEQ ID NO: 4 - DNA, 61 bp, Artificial
  Blocking Oligonucleotide BO4
agatcggaagagcggttcagcaggaatgccgagaccgatctcgtatgccgtcttctgcttg

SEQ ID NO: 5 - DNA, 10 bp, Artificial
  Target DNA insert plus strand
tccgatgaga

SEQ ID NO: 6 - DNA, 10 bp, Artificial
  Target DNA insert minus strand
tctcatcgga

SEQ ID NO: 7 - DNA, 10 bp, Artificial
  Target DNA insert plus strand after gel extraction, bisulfite conversion and desulphonation.
tncgatgaga

SEQ ID NO: 8 - DNA, 10 bp, Artificial
  Target DNA insert minus strand after gel extraction, bisulfite conversion and desulphonation.
tntnatcgga

SEQ ID NO: 9 - DNA, 10 bp, Artificial
  PCR amplified converted template plus strand (T-rich)
ttcgatgaga

SEQ ID NO: 10 - DNA, 10 bp, Artificial
  PCR amplified converted template plus strand (A-rich)
tctcatcgaa

SEQ ID NO: 11 - DNA, 10 bp, Artificial
  PCR amplified converted template minus strand (A-rich)
tccgataaaa

SEQ ID NO: 12 - DNA, 10 bp, Artificial
  PCR amplified converted template minus strand (T-rich)
ttttatcgga

SEQ ID NO: 13 - DNA, 10 bp, Artificial
  Array Probe 1
tttgatgaga

SEQ ID NO: 14 - DNA, 10 bp, Artificial
  Array Probe 2
ttcgatgaga

SEQ ID NO: 15 - DNA, 10 bp, Artificial
  Array Probe 3
ttttatcgga

SEQ ID NO: 16 - DNA, 10 bp, Artificial
  Array Probe 4
ttttattgga

SEQ ID NO: 17 - DNA, 10 bp, Artificial
  Single Read Sequence
acggtgttcg

SEQ ID NO: 18 - DNA, 10 bp, Artificial
  Candidate genome mapping Site A
acgtcgctcg

SEQ ID NO: 19 - DNA, 10 bp, Artificial
  Candidate genome mapping Site B
atgctgtccg

SEQ ID NO: 20 - DNA, 34 bp, Homo sapiens
ggttcgccttggtggccagggtgcggggcaccag

SEQ ID NO: 21 - DNA, 34 bp, Artificial
  Bisulfite Sequence Capture - SOLEXA
ggttcgttttggtggttagggtgcggggtattag

SEQ ID NO: 22 - DNA, 34 bp, Artificial; identical to SEQ ID NO: 21
  Bisulfite - Conventional

SEQ ID NO: 23 - DNA, 31 bp, Homo sapiens
cacgggcagcacgaagcccaggaccaacgtg

SEQ ID NO: 24 - DNA, 31 bp, Artificial
  Bisulfite Sequence Capture - SOLEXA
taygggtagtacgaagtttaggattaaygtg

SEQ ID NO: 25 - DNA, 31 bp, Artificial; identical to SEQ ID NO: 24
  Bisulfite - Conventional